(19) United States
(12) Patent Application Publication
(10) Pub. No.: US 2022/0044344 A1
(43) Pub. Date: Feb. 10, 2022

(54) SYSTEMS AND METHODS FOR USING RIDESHARING VEHICLES AND PERSONAL TRANSPORTATION VEHICLES

(71) Applicant: VIA TRANSPORTATION, INC., New York, NY (US)

(72) Inventors: Daniel RAMOT, New York, NY (US); Oren SHOVAL, Jerusalem (IL); Shmulik MARCOVITCH, Kfar Saba (IL); Guy SHER, Tel Aviv (IL)

(73) Assignee: VIA TRANSPORTATION, INC., New York, NY (US)

(21) Appl. No.: 17/414,683

(22) PCT Filed: Dec. 12, 2019
(86) PCT No.: PCT/US19/65899

§ 371 Date: Jun. 16, 2021

Related U.S. Application Data
(60) Provisional application No. 62/780,581, filed on Dec. 17, 2018.
(60) Provisional application No. 62/802,430, filed on Feb. 7, 2019.

(51) Int. Cl. G06Q 50/30; G06Q 10/04

(52) U.S. Cl. CPC G06Q 50/30; G06Q 10/047

(57) ABSTRACT

The present disclosure relates to systems and methods for managing a fleet of multi-person transportation vehicles and a fleet of personal transportation vehicles. In some implementations, an urban mobility management system is provided. The system may determine first transportation routes for a plurality of users. The first transportation routes include at least one route in which a user uses a personal transportation vehicle for transportation and at least one route in which another user uses a multi-person transportation vehicle for transportation. The system may also determine second transportation routes for a plurality of personal transportation vehicles. The second transportation routes include at least one route in which a personal transportation vehicle is being relocated by a multi-person transportation vehicle. The system may also provide driving instructions to at least one multi-person transportation vehicle for transporting multiple users and at least personal transportation vehicle.

### CROSS REFERENCES TO RELATED APPLICATIONS

This application claims the benefit of priority of U.S. Provisional Patent Application No. 62/780,581, filed Dec. 17, 2018, and U.S. Provisional Patent Application No. 62/802,430, filed Feb. 7, 2019. All of the foregoing applications are incorporated herein by reference in their entirety.

### BACKGROUND

### I. Technical Field

The present disclosure generally relates to the field of vehicle ridesharing and systems and methods for ridesharing management.

### II. Background Information

Recent years have witnessed increasing interest and development in urban mobility. One branch of urban mobility that continuously grows is ridesharing. In ridesharing, one or more riders may share the same multi-person transportation vehicle for a portion of their rides. Ridesharing may save ride costs, increase vehicle utilization, and reduce air pollution. Currently, a rider can use a ridesharing service through a ridesharing service application accessed by the rider's mobile device. Another branch of urban mobility that has gained popularity lately is the rental of personal transportation vehicles (e.g., electric scooters). Many cities around the globe have personal transportation vehicles for rent scattered throughout the cities. The personal transportation vehicles provide a fast and convenient way to get around and also helps to reduce air pollution. Currently, a rider may rent a personal transportation vehicle through a dedicated service application accessed by the rider's mobile device.

The present disclosure describes methods and system for combining these two aspects of urban mobility and provide a single comprehensive transportation service.

### SUMMARY

Embodiments consistent with the present disclosure provide systems and methods for managing a fleet of multi-person transportation vehicles and a fleet of personal transportation vehicles. For example, consistent with the disclosed embodiments, each fleet of vehicles may include more than 3 vehicles, more than 100 vehicles, or more than 1000 vehicles that provide transportation services to users.

In one embodiment, a system for providing transportation is provided. The system may include a communications interface configured to receive location information from a first plurality of communication devices associated with a plurality of personal transportation vehicles; receive location information from a second plurality of communication devices associated with a plurality of multi-person transportation vehicles; and receive ride requests from a third plurality of communication devices associated with a plurality of users, wherein each ride request includes a starting point and a desired destination corresponding to each of the plurality of users. The system may also include at least one processor configured to determine optional transportation routes for the plurality of users based on the ride requests, the location information from the plurality of personal transportation vehicles, and the location information from the plurality of multi-personal transportation vehicles. The at least one processor may also determine a transportation route for a user among the plurality of users, wherein the transportation route includes at least one segment in which the user is assigned to a personal transportation vehicle among the plurality of personal transportation vehicles and at least one segment in which the user is assigned to a multi-person transportation vehicle among the plurality of multi-transportation vehicles. The at least one processor may further provide the user with information about the transportation route. The information includes details about a collection point from which the user is scheduled to collect the assigned personal transportation vehicle and details about a pick-up location from which the assigned multi-person transportation vehicle is scheduled to pick up the user.

In another embodiment, a method for providing transportation is provided. The method may include receiving location information from a first plurality of communication devices associated with a plurality of personal transportation vehicles; receiving location information from a second plurality of communication devices associated with a plurality of multi-person transportation vehicles; receiving ride requests from a third plurality of communication devices associated with a plurality of users, wherein each ride request includes a starting point and a desired destination corresponding to each of the plurality of users; determining optional transportation routes for the user based on a corresponding ride request, the location information from the plurality of personal transportation vehicles, and the location information from the plurality of multi-personal transportation vehicles; determining a first transportation route proposal for the user that includes using at least a personal transportation vehicle from the plurality of personal transportation vehicles, wherein the first transportation route proposal is associated with a first travel time; determining a second transportation route proposal for the user that includes using at least a multi-personal transportation vehicle from the plurality of multi-transportation vehicles, wherein the second transportation route proposal is associated with a second travel time other than the first travel time; providing the user information associated with the first transportation route proposal and the second transportation route proposal; receiving from the user a proposal selection reflective of at least one selected vehicle for transportation; and assigning the at least one selected vehicle to the user based on the received proposal selection.

In another embodiment, a system for managing transportation of users and personal transportation vehicles is provided. The system may include a communications interface configured to: receive information from a first plurality of communication devices associated with a plurality of personal transportation vehicles; receive information from a second plurality of communication devices associated with a plurality of multi-person transportation vehicles; and receive ride requests from a third plurality of communication devices associated with a plurality of users, wherein each ride request includes a starting point and a desired destination corresponding to each of the plurality of users. The system may also include at least one processor configured to determine first transportation routes for the plurality of users based on the received ride requests. The first transportation routes may include at least one route in which a user among the plurality of users uses a personal transportation vehicle among the plurality of personal transportation vehicles for transportation and at least one route in which another user among the plurality of users uses a multi-person transportation vehicle among the plurality of multi-transportation vehicles for transportation. The at least one processor may also use the information received from the first plurality of communication devices to identify a need for relocating the plurality of personal transportation vehicles to different locations. Based on the identified need, the at least one processor may determine second transportation routes for the plurality of personal transportation vehicles. The second transportation routes may include at least one route in which one of the plurality of personal transportation vehicles is relocated by one of the plurality of multi-person transportation vehicles. The at least one processor may further provide driving instructions to at least one of the plurality of multi-person transportation vehicles for transporting multiple users and at least one of the plurality of personal transportation vehicles.

Consistent with other disclosed embodiments, non-transitory computer-readable storage media may store program instructions, which are executed by at least one processing device and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute part of this disclosure, illustrate various example embodiments. In the drawings:

FIG. 1 is a diagram illustrating an example urban mobility management system, in accordance with some embodiments of the present disclosure.

FIG. 2 is a diagram illustrating the components of an example mobile communications device associated with an urban mobility management system, in accordance with some embodiments of the present disclosure.

FIG. 3 is a diagram illustrating the components of an example server associated with an urban mobility management system, in accordance with some embodiments of the present disclosure.

FIGS. 4A and 4B are flowcharts of example processes for vehicle ridesharing management, in accordance with some embodiments of the present disclosure.

FIG. 5 is a diagram of example timelines showing ridesharing arrangements, in accordance with some embodiments of the present disclosure.

FIG. 6 is a diagram of five timelines illustrating different multi-leg transportation routes, in accordance with some embodiments of the present disclosure.

FIG. 7 is an illustration of example three optional transportation routes that an urban mobility management system determined for a user, in accordance with some embodiments of the present disclosure.

FIG. 8 depicts two screenshots illustrating an example graphical user interface (GUI) for providing transportation proposals to a user, in accordance with some embodiments of the present disclosure.

FIG. 9 is a block chart illustrating an exemplary embodiment of a memory containing software modules consistent with some embodiments of the present disclosure.

FIG. 10 is a flowchart of an example process used by an urban mobility management system to provide transportation, in accordance with some embodiments of the present disclosure.

FIG. 11 is a flowchart of an example process used by an urban mobility management system to provide users multiple transportation proposals, in accordance with some embodiments of the present disclosure.

FIG. 12 is an illustration of example three transportation routes that an urban mobility management system determined for a plurality of users, in accordance with some embodiments of the present disclosure.

FIG. 13 is a diagram of illustrating a journey of a multi-person transportation vehicle, in accordance with some embodiments of the present disclosure.

FIG. 14 is an illustration of a plurality of example transportation routes that an urban mobility management system determined for a plurality of personal transportation vehicles in accordance with some embodiments of the present disclosure.

FIG. 15 is a flowchart of an example method for managing transportation of users and personal transportation vehicles, in accordance with some embodiments of the present disclosure.

FIG. 16 is a diagram illustrating the components of an example personal transportation vehicle, in accordance with some embodiments of the present disclosure.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Disclosed embodiments of the present disclosure provide methods and systems for vehicle ridesharing and vehicle ridesharing management. The term “ridesharing vehicle” or “multi-person transportation vehicle” as used herein refers to any kind of vehicle (e.g., car, van, SUV, truck, bus, etc.) suitable for transporting more than one individual, such as providing ride services. In some embodiments, a vehicle may be a taxi. In some embodiments, a vehicle may include an autonomous vehicle, wherein a control device integrated with the vehicle or a management system separate from the vehicle may send operational instructions and guide the vehicle to designated pick-up locations and drop-off locations. For the ease and conciseness of description, some embodiments disclosed herein may simply refer to a vehicle or a taxi as an example, which does not limit the scope of the disclosed embodiments.

Consistent with some embodiments of the present disclosure, an urban mobility management system may receive a first ride request from a first user. The first ride request may include a starting point and a desired destination. Consistent with the present disclosure, the urban mobility management system may propose the first user a plurality of transportation options, such as ridesharing, scooter rental, or a combination of both. In one embodiment, the system may calculate a first estimated pick-up time based on a current location of a vehicle that is in the surrounding areas. After sending a confirmation with the estimated pick-up time, the urban mobility management system may then guide the vehicle to a pick-up location for picking up the first rider. The pick-up location may be a different location from the starting point included in the first ride request. The system may also guide the first user to the pick-up location. Thereafter, the system may subsequently receive a second ride request from a second user, for example, while the first user is still in the vehicle. The second ride request may include a second starting point and a second desired destination. The system may calculate a second estimated pick-up time, provide a second confirmation to the second rider, and guide the second rider to a second pick-up location. In some embodiments, the second pick-up location may be a different location from the second starting point included in the second ride request.

In some embodiments, the system may calculate the fares for each user, based on the type of vehicle used, the solo ride portion for a corresponding user, and the shared portion of the ride each of which can correspond to the whole ride as well. For example, the system may offer a discount for the shared portion of the ride. In some embodiments, the system may also calculate the fare amount for a particular user based on various service-related parameters, such as user input regarding whether to use toll roads, the walking distance between the starting point and the pick-up location, and the walking distance between the desired destination and the drop-off location.

The embodiments herein further include computer-implemented methods, tangible non-transitory computer-readable mediums, and systems. The computer-implemented methods can be executed, for example, by at least one processor that receives instructions from a non-transitory computer-readable storage medium. Similarly, systems and devices consistent with the present disclosure can include at least one processor and memory, and the memory can be a non-transitory computer-readable storage medium. As used herein, a “non-transitory computer-readable storage medium” refers to any type of physical memory on which information or data readable by at least one processor can be stored. Examples include random access memory (RAM), read-only memory (ROM), volatile memory, nonvolatile memory, hard drives, CD ROMs, DVDs, flash drives, disks, and any other known physical storage medium. Singular terms, such as “memory” and “computer-readable storage medium,” can additionally refer to multiple structures, such a plurality of memories or computer-readable storage mediums. As referred to herein, a “memory” may comprise any type of computer-readable storage medium unless otherwise specified. A computer-readable storage medium may store instructions for execution by at least one processor, including instructions for causing the processor to perform steps or stages consistent with an embodiment herein. Additionally, one or more computer-readable storage mediums may be used in implementing a computer-implemented method. The term “computer-readable storage medium” should be understood to include tangible items and exclude carrier waves and transient signals.

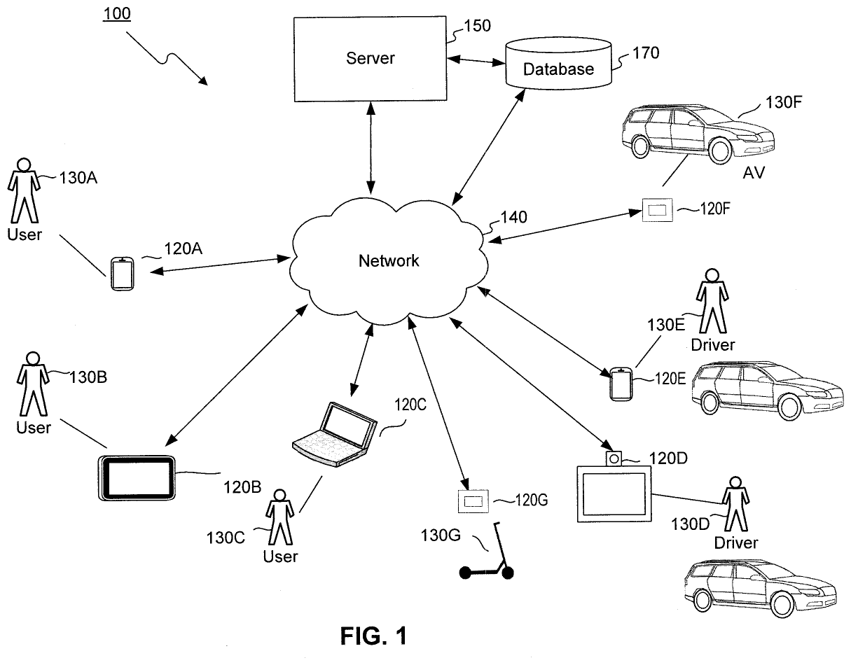

FIG. 1 is a diagram illustrating an example urban mobility management system, in which various implementations as described herein may be practiced, according to some embodiments of the present disclosure. As shown in FIG. 1, urban mobility management system 100 includes one or more mobile communications devices 120A-120F (collectively referred to as mobile communications devices 120), a network 140, a server 150, and a database 170. The plurality of mobile communications devices 120A-120F may further include a plurality of user devices 120A-120C associated with users 130A-130C respectively, a plurality of driver devices 120D and 120E associated with drivers 130D and 130E, a driving-control device 120F associated with an autonomous vehicle 130F, and at least one communication device 120G associated with at least one personal transportation vehicle 130G. Consistent with some embodiments of the present disclosure, server 150 may communicate with driving-control device 120F to direct autonomous vehicle 130F to pick up and drop off users 130A-130C. In one example, autonomous vehicles capable of detecting objects on the road and navigate to designated locations may be utilized for providing ridesharing services.

The components and arrangements shown in FIG. 1 are not intended to limit the disclosed embodiments, as the system components used to implement the disclosed processes and features can vary. For example, urban mobility management system 100 may include multiple servers 150, and each server 150 may handle a certain category of services. For example, services associated with a certain category of service vehicles (e.g., personal transportation vehicles or multi-person transportation vehicles), or transportation services in a specific geographical region. The plurality of servers 150 may collectively provide a dynamic and integrated urban mobility service system.

Network 140 may facilitate communications between communications devices 120 and server 150, for example, receiving ride requests and other ride server related input from or sending confirmations to user devices, and sending ride service assignments to driver devices and driving-control devices. Network 140 may be any type of networks that provides communications, exchanges information, and/or facilitates the exchange of information between server 150 and communications devices 120. For example, network 140 may be the Internet, a Local Area Network, a cellular network, a public switched telephone network (“PSTN”), or other suitable connection(s) that enables urban mobility management system 100 to send and receive information between the components of urban mobility management system 100. Network 140 may support a variety of messaging formats, and may further support a variety of services and applications for communications devices 120. For example, network 140 may support navigation services for mobile communications devices 120, such as directing the users and service vehicles to pick-up or drop-off locations.

Server 150 may be a system associated with a communication service provider which provides a variety of data or services, such as voice, messaging, real-time audio/video, to users, such as users 130A-130E. Server 150 may be a computer-based system including computer system components, desktop computers, workstations, tablets, handheld mobile communications devices, memory devices, and/or internal network(s) connecting the components. Server 150 may be configured to receive information from mobile communications devices 120 over network 140, process the information, store the information, and/or transmit information to mobile communications devices 120 over network 140.

For example, in some embodiments, server 150 may be configured to: receive ride requests from user devices 120A-120C, send ride confirmation and ride fare information to user devices 120A-120C, and send ride service assignments (for example, including pick-up and drop-off location information) to driver devices 120D and 120E, and driving-control device 120F. Further, server 150 may further be configured to receive user input from user devices 120A-120C as to various ride service parameters, such as walking distance to a pick-up location, maximum delay of arrival/detour, and maximum number of subsequent pick-ups, etc. In some embodiments, server 150 may be further configured to: calculate ride fares based on a solo portion of a user's ride and a shared portion of the ride. Further, the ride fare calculation may further be based on various ride service parameters set by the user, such as the walking distance involved in the ride and user selection regarding toll road usage, etc.

Database 170 may include one or more physical or virtual storages coupled with server 150. Database 170 may be configured to store user account information (including registered user accounts and driver accounts), corresponding user profiles such as contact information, profile photos, and associated mobile communications device information. With respect to users, user account information may further include ride history, service feedbacks, complaints, or comments. With respect to drivers, user account information may further include number of ride service assignments completed, ratings, and ride service history information. Database 170 may further be configured to store various ride requests received from user devices 120A-120C and corresponding starting point and desired destination information, user input regarding various service parameters, pick-up and drop-off locations, time of pick-up and drop-off, ride fares, and user feedback, etc.

Database 170 may further include traffic data, maps, and toll road information, which may be used for ridesharing service management. Traffic data may include historical traffic data and real-time traffic data regarding a certain geographical region, and may be used to, for example, calculate estimated pick-up and drop-off times, and determine an optimal route for a particular ride. Real-time traffic data may be received from a real-time traffic monitoring system, which may be integrated in or independent from urban mobility management system 100. Maps may include map information used for navigation purposes, for example, for calculating potential routes and guiding the users to a pick-off or drop-off location. Toll road information may include toll charges regarding certain roads, and any change or updates thereof. Toll road information may be used to calculate ride fares, for example, in cases where the user permits use of toll roads.

The data stored in database 170 may be transmitted to server 150 for accommodating ride requests. In some embodiments, database 170 may be stored in a cloud-based server (not shown) that is accessible by server 150 and/or mobile communications devices 120 through network 140. While database 170 is illustrated as an external device connected to server 150, database 170 may also reside within server 150 as an internal component of server 150.

As shown in FIG. 1, users 130A-130E may include a plurality of users 130A-130C, and a plurality of drivers 130D and 130E, who may communicate with one another, and with server 150 using various types of mobile communications devices 120. As an example, a mobile communications device 120 may include a display such as a television, tablet, computer monitor, video conferencing console, or laptop computer screen. A mobile communications device 120 may further include video/audio input devices such as a microphone, video camera, keyboard, web camera, or the like. For example, a mobile communications device 120 may include mobile devices such as a tablet or a smartphone having display and video/audio capture capabilities. A mobile communications device 120 may also include one or more software applications that facilitate the mobile communications devices to engage in communications, such as IM, VoIP, video conferences. For example, user devices 120A-120C may send requests to server 150, and receive confirmations therefrom. Drivers 130D and 130E may use their respective devices to receive ride service assignments and navigation information from server 150, and may contact the users with their respective devices 120D and 120E.

In some embodiments, a user may directly hail a vehicle by hand gesture or verbal communication, such as traditional street vehicle hailing. In such embodiments, once a driver accepts the request, the driver may then use his device to input the ride request information. Server 150 may receive such request information, and accordingly assign one or more additional ride service assignments to the same vehicle, for example, subsequent e-hail ride requests received from other mobile communications devices 120 through network 140.

In some embodiments, driver devices 120D and 120E, and driving-control device 120F may be embodied in a vehicle control panel, as a part of the vehicle control system associated with a particular vehicle. For example, a traditional taxi company may install a drive device in all taxi vehicles managed by the taxi company. In some embodiments, driver devices 120D and 120E, driving-control device 120F, and communication device 120G, may be further coupled with a payment device, such as a card reader installed as a part of the vehicle control panel or as a separate device associated with the vehicle. A user may then use the payment device as an alternative payment mechanism. For example, a user who hails the taxi on the street may pay through the payment device without using a user device providing ridesharing service.

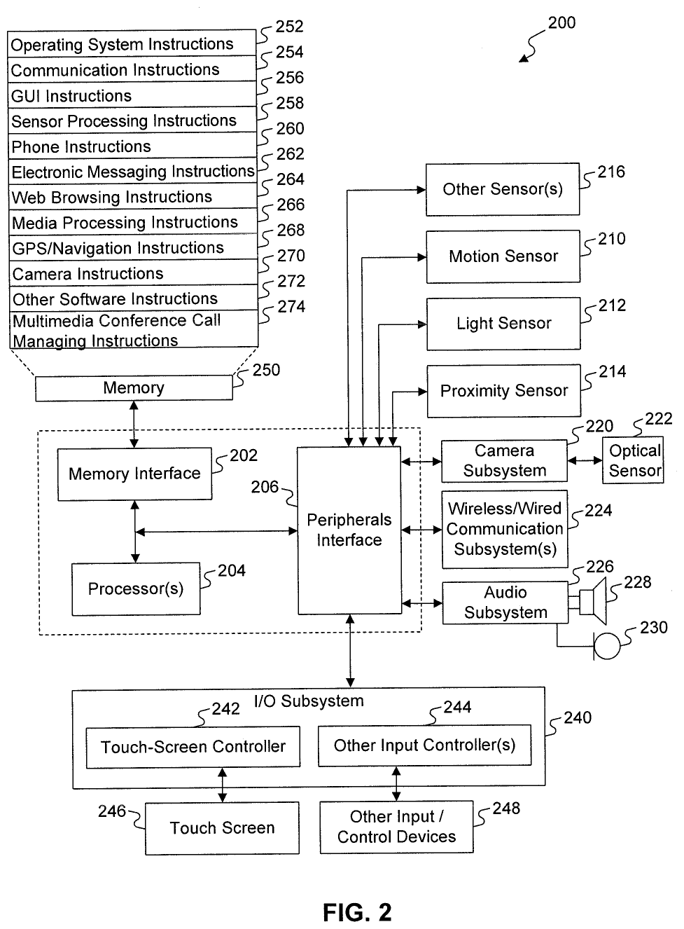

FIG. 2 is a diagram illustrating the components of an example mobile communications device 200 associated with an urban mobility management system, such as system 100 as shown in FIG. 1, in accordance with some embodiments of the present disclosure. Mobile communications device 200 may be used to implement computer programs, applications, methods, processes, or other software to perform embodiments described in the present disclosure, such as mobile communications devices 120A-120F. For example, user devices 120A-120C, driver devices 120D and 120E, and driving-control device 120F may respectively be installed with a user side ridesharing application, and a corresponding driver side ridesharing application.

Mobile communications device 200 includes a memory interface 202, one or more processors 204 such as data processors, image processors and/or central processing units and a peripherals interface 206. Memory interface 202, one or more processors 204, and/or peripherals interface 206 can be separate components or can be integrated in one or more integrated circuits. The various components in mobile communications device 200 may be coupled by one or more communication buses or signal lines.

Sensors, devices, and subsystems can be coupled to peripherals interface 206 to facilitate multiple functionalities. For example, a motion sensor 210, a light sensor 212, and a proximity sensor 214 may be coupled to peripherals interface 206 to facilitate orientation, lighting, and proximity functions. Other sensors 216 may also be connected to peripherals interface 206, such as a positioning system (e.g., GPS receiver), a temperature sensor, a biometric sensor, or other sensing device to facilitate related functionalities. A GPS receiver may be integrated with, or connected to, mobile communications device 200. For example, a GPS receiver may be included in mobile telephones, such as smartphone devices. GPS software may allow mobile telephones to use an internal or external GPS receiver (e.g., connecting via a serial port or Bluetooth). A camera subsystem 220 and an optical sensor 222, e.g., a charged coupled device (“CCD”) or a complementary metal-oxide semiconductor (“CMOS”) optical sensor, may be used to facilitate camera functions, such as recording photographs and video clips.

Communication functions may be facilitated through one or more wireless/wired communication subsystems 224, which includes a Ethernet port, radio frequency receivers and transmitters and/or optical (e.g., infrared) receivers and transmitters. The specific design and implementation of wireless/wired communication subsystem 224 may depend on the communication network(s) over which mobile communications device 200 is intended to operate. For example, in some embodiments, mobile communications device 200 may include wireless/wired communication subsystems 224 designed to operate over a GSM network, a GPRS network, an EDGE network, a Wi-Fi or WiMax network, and a Bluetooth® network.

An audio subsystem 226 may be coupled to a speaker 228 and a microphone 230 to facilitate voice-enabled functions, such as voice recognition, voice replication, digital recording, and telephony functions.

I/O subsystem 240 may include touch screen controller 242 and/or other input controller(s) 244. Touch screen controller 242 may be coupled to touch screen 246. Touch screen 246 and touch screen controller 242 may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen 246. While touch screen 246 is shown in FIG. 2, I/O subsystem 240 may include a display screen (e.g., CRT or LCD) in place of touch screen 246.

Other input controller(s) 244 may be coupled to other input/control devices 248, such as one or more buttons, rocker switches, thumb-wheel, infrared port, USB port, and/or a pointer device such as a stylus. Touch screen 246 may, for example, also be used to implement virtual or soft buttons and/or a keyboard.

Memory interface 202 may be coupled to memory 250. Memory 250 includes high-speed random access memory and/or non-volatile memory, such as one or more magnetic disk storage devices, one or more optical storage devices, and/or flash memory (e.g., NAND, NOR).

Memory 250 may store an operating system 252, such as DRAWIN, RTXC, LINUX, iOS, UNIX, OS X, WINDOWS, or an embedded operating system such as VXWorkS. Operating system 252 may include instructions for handling basic system services and for performing hardware dependent tasks. In some implementations, operating system 252 can be a kernel (e.g., UNIX kernel).

Memory 250 may also store communication instructions 254 to facilitate communicating with one or more additional devices, one or more computers and/or one or more servers. Memory 250 can include graphical user interface instructions 256 to facilitate graphic user interface processing; sensor processing instructions 258 to facilitate sensor-related processing and functions; phone instructions 260 to facilitate phone-related processes and functions; electronic messaging instructions 262 to facilitate electronic-messaging related processes and functions; web browsing instructions 264 to facilitate web browsing-related processes and functions; media processing instructions 266 to facilitate media processing-related processes and functions; GPS/navigation instructions 268 to facilitate GPS and navigation-related processes and instructions; camera instructions 270 to facilitate camera-related processes and functions; and/or other software instructions 272 to facilitate other processes and functions.

In some embodiments, communication instructions 254 may include software applications to facilitate connection with server 150 that handles vehicle ridesharing requests. Graphical user interface instructions 256 may include a software program that facilitates a user associated with the mobile communications device to receive messages from server 150, provide user input, and so on. For example, a user may send ride requests and ride service parameters to server 150 and receive ridesharing proposals and confirmation messages. A driver may receive ride service assignments from server 150, and provide ride service status updates.

Each of the above identified instructions and applications may correspond to a set of instructions for performing one or more functions described above. These instructions need not be implemented as separate software programs, procedures, or modules. Memory 250 may include additional instructions or fewer instructions. Furthermore, various functions of mobile communications device 200 may be implemented in hardware and/or in software, including in one or more signal processing and/or application specific integrated circuits.

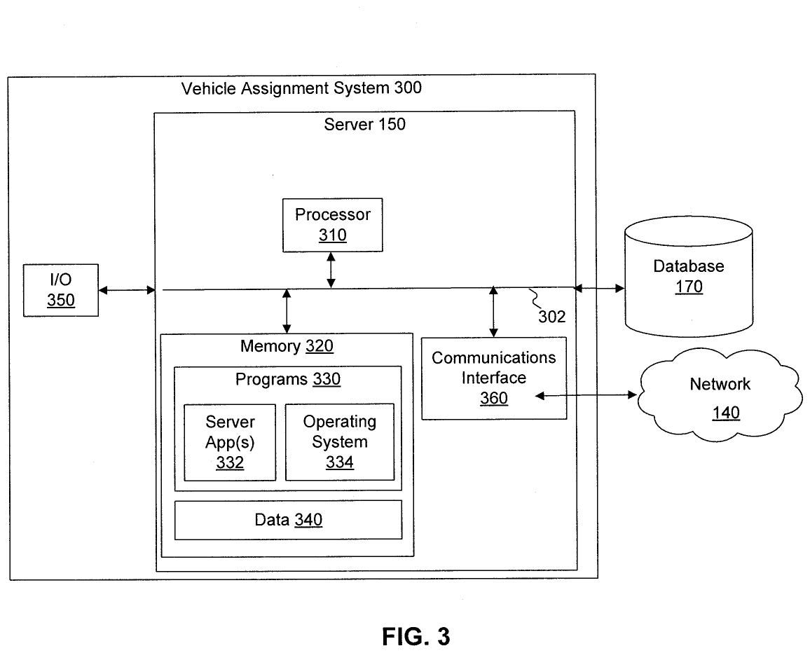

FIG. 3 is a diagram illustrating the components of an example vehicle assignment system 300 that includes server 150 associated with urban mobility management system 100, in accordance with some embodiments of the present disclosure. Server 150 may include a bus 302 (or other communication mechanism), which interconnects subsystems and components for transferring information within server 150.

As shown in FIG. 3, vehicle assignment system 300 may include one or more processors 310, one or more memories 320 storing programs 330 including, for example, server app(s) 332, operating system 334, and data 340, and a communications interface 360 (e.g., a modem, Ethernet card, or any other interface configured to exchange data with a network, such as network 140 in FIG. 1). Vehicle assignment system 300 may communicate with an external database 170 (which, for some embodiments, may be included within server 150). Vehicle assignment system 300 may include a single server (e.g., server 150) or may be configured as a distributed computer system including multiple servers, server farms, clouds, or computers that interoperate to perform one or more of the processes and functionalities associated with the disclosed embodiments. The term “cloud server” refers to a computer platform that provides services via a network, such as the Internet. When server 150 is a cloud server it may use virtual machines that may not correspond to individual hardware. Specifically, computational and/or storage capabilities may be implemented by allocating appropriate portions of desirable computation/storage power from a scalable repository, such as a data center or a distributed computing environment.

Processor 310 may be one or more processing devices configured to perform functions of the disclosed methods, such as a microprocessor manufactured by Intel™ or manufactured by AMD™. Processor 310 may comprise a single core or multiple core processors executing parallel processes simultaneously. For example, processor 310 may be a single core processor configured with virtual processing technologies. In certain embodiments, processor 310 may use logical processors to simultaneously execute and control multiple processes. Processor 310 may implement virtual machine technologies, or other technologies to provide the ability to execute, control, run, manipulate, store, etc. multiple software processes, applications, programs, etc. In some embodiments, processor 310 may include a multiple-core processor arrangement (e.g., dual, quad core, etc.) configured to provide parallel processing functionalities to allow server 150 to execute multiple processes simultaneously. It is appreciated that other types of processor arrangements could be implemented that provide for the capabilities disclosed herein.

Memory 320 may be a volatile or non-volatile, magnetic, semiconductor, tape, optical, removable, non-removable, or other type of storage device or tangible or non-transitory computer-readable medium that stores one or more program(s) 330 such as server apps 332 and operating system 334, and data 340. Common forms of non-transitory media include, for example, a flash drive, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Server 150 may include one or more storage devices configured to store information used by processor 310 (or other components) to perform certain functions related to the disclosed embodiments. For example, server 150 may include memory 320 that includes instructions to enable processor 310 to execute one or more applications, such as server apps 332, operating system 334, and any other type of application or software known to be available on computer systems. Alternatively or additionally, the instructions, application programs, etc., may be stored in an external database 170 (which can also be internal to server 150) or external storage communicatively coupled with server 150 (not shown), such as one or more database or memory accessible over network 140.

Database 170 or other external storage may be a volatile or non-volatile, magnetic, semiconductor, tape, optical, removable, non-removable, or other type of storage device or tangible or non-transitory computer-readable medium. Memory 320 and database 170 may include one or more memory devices that store data and instructions used to perform one or more features of the disclosed embodiments. Memory 320 and database 170 may also include any combination of one or more databases controlled by memory controller devices (e.g., server(s), etc.) or software, such as document management systems, Microsoft SQL databases, SharePoint databases, Oracle™ databases, Sybase™ databases, or other relational databases.

In some embodiments, server 150 may be communicatively connected to one or more remote memory devices (e.g., remote databases (not shown)) through network 140 or a different network. The remote memory devices can be configured to store information that server 150 can access and/or manage. By way of example, the remote memory devices may include document management systems, Microsoft SQL database, SharePoint databases, Oracle™ databases, Sybase™ databases, or other relational databases. Systems and methods consistent with disclosed embodiments, however, are not limited to separate databases or even to the use of a database.

Programs 330 may include one or more software modules causing processor 310 to perform one or more functions of the disclosed embodiments. Moreover, processor 310 may execute one or more programs located remotely from one or more components of the urban mobility management system 100. For example, server 150 may access one or more remote programs that, when executed, perform functions related to disclosed embodiments.

In the presently described embodiment, server app(s) 332 may cause processor 310 to perform one or more functions of the disclosed methods. For example, devices associated with users, drivers and autonomous vehicles may respectively be installed with user applications for vehicle ridesharing services, and driver applications for vehicle ridesharing services. Further, a mobile communications device may be installed with both the driver applications and the user applications, for uses in corresponding situations.

In some embodiments, other components of urban mobility management system 100 may be configured to perform one or more functions of the disclosed methods. For example, mobile communications devices 120 may be configured to calculate estimated pick-up and drop-off times based on a certain ride request, and may be configured to calculate estimate ride fares. As another example, mobile communications devices 120 may further be configured to provide navigation service and location service, such as directing the user to a particular pick-up or drop-off location, and providing information about a current location of the respective user or vehicle to server 150.

In some embodiments, program(s) 330 may include operating system 334 performing operating system functions when executed by one or more processors such as processor 310. By way of example, operating system 334 may include Microsoft Windows™, Unix™ Linux™, Apple™ operating systems, Personal Digital Assistant (PDA) type operating systems, such as Apple iOS, Google Android, Blackberry OS, Microsoft CE™, or other types of operating systems. Accordingly, the disclosed embodiments may operate and function with computer systems running any type of operating system 334. Server 150 may also include software that, when executed by a processor, provides communications with network 140 through communications interface 360 and/or a direct connection to one or more mobile communications devices 120. Specifically, communications interface 360 may be configured to receive ride requests (e.g., from user devices 120A-120C) headed to differing destinations, and receive indications of the current locations of the ridesharing vehicles (e.g., from driver devices 120D and 120E or driving-control device 120F). In one example, communications interface 360 may be configured to continuously or periodically receive current vehicle location data for the plurality of ridesharing vehicles that are part of urban mobility management system 100. The current vehicle location data may include global positioning system (GPS) data generated by at least one GPS component of a mobile communications device 120 associated with each ridesharing vehicle.

In some embodiments, data 340 may include, for example, profiles of users, such as user profiles or driver profiles. Data 340 may further include ride requests from a plurality of users, user ride history and driver service record, and communications between a driver and a user regarding a particular ride request. In some embodiments, data 340 may further include traffic data, toll road information, and navigation information, which may be used for handling and accommodating ride requests.

Vehicle assignment system 300 may also include one or more I/O devices 350 having one or more interfaces for receiving signals or input from devices and providing signals or output to one or more devices that allow data to be received and/or transmitted by vehicle assignment system 300. For example, vehicle assignment system 300 may include interface components for interfacing with one or more input devices, such as one or more keyboards, mouse devices, and the like, that enable vehicle assignment system 300 to receive input from an operator or administrator (not shown).

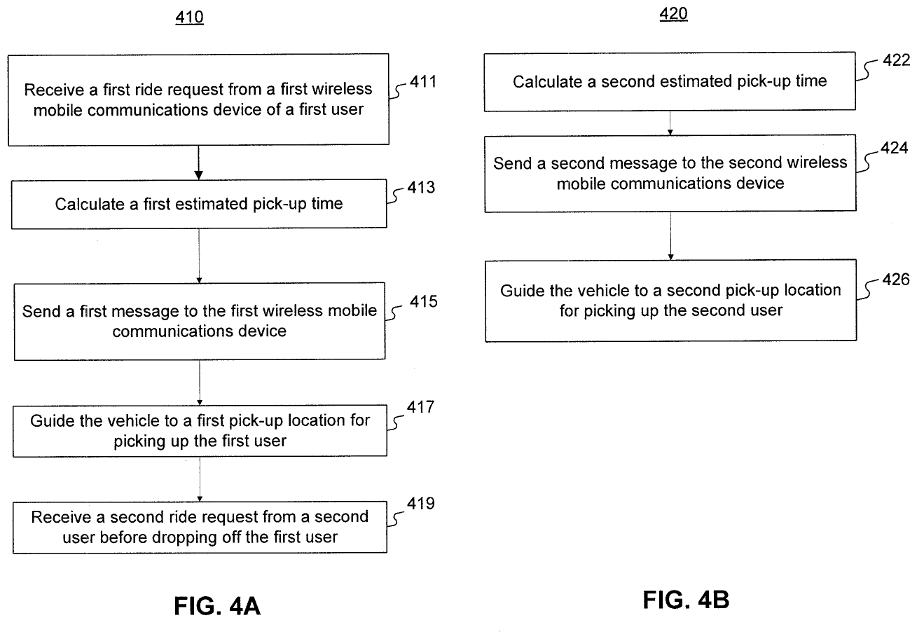

FIGS. 4A and 4B are flowcharts of example processes 410 and 420 for vehicle ridesharing management, in accordance with some embodiments of the present disclosure. In one embodiment, all of the steps of process 400 may be performed by a server, such as server 150 described above with reference to FIGS. 1 and 3. Alternatively, at least some of the steps of process 400 may be performed by a mobile communications device, such as the mobile communications devices 120 described above with reference to FIGS. 1 and 2. In the following description, reference is made to certain components of FIGS. 1-3 for purposes of illustration. It will be appreciated, however, that other implementations are possible and that other components may be utilized to implement example methods disclosed herein.

At step 411, server 150 may receive a first ride request from a first wireless communication of a first user, for example, a request from user 130A sent through user device 120A. The first ride request may include a first starting point and a first desired destination. A ride request may refer to a request from a user needing transportation service from a certain location to another. A starting point may refer to a current location of the user, as input by the user through an input device of an associated user device, or as determined by a location service application installed on the user device. In some embodiments, the starting point may be a location different from the current location of the user, for example, a location where the user will subsequently arrive at (e.g., entrance of a building). A desired destination may refer to a location where the user requests to be taken to.

In some embodiments, the actual pick-up location and the actual drop-off location may be different from the starting point and the desired destination. For example, the pick-up location may be of a certain distance from the starting point, where the user may be directed to for pick-up. By encouraging the user to walk to a pick-up location nearby, consistent with some embodiments, the vehicle may more easily and quickly locate the user without excessive detour, or causing excessive delay for users who are in the vehicle. Similarly, by encouraging the user to walk from a drop-off location different from but within a certain distance from the desired destination, the vehicle may be able to accommodate subsequent pick-ups, or arrive at the subsequent pick-up locations more quickly. The vehicle ridesharing service management system may provide incentives or rewards for the user who are willing to walk a certain distance. For example, the urban mobility management system may offer certain discounts based on the number and distances of the walks involved in a particular ride. Alternatively, the urban mobility management system may offer ride credits corresponding to the number and distance of the walks undertaken by the user during his rides. The user may use the credits for subsequent ride payment, or redeem the credit for money, free rides, or other rewards. Further, advantages of such embodiments may include more efficient vehicle use and management, more user flexibility, and less air pollution associated with vehicle use.

In some embodiments, prior to or after the user sends a ride request to server 150, the user may further input ride service parameters through, for example, a settings component provided on a user interface. Ride service parameters refer to user preference parameters regarding a vehicle ridesharing service, for example, a maximum walking distance from the starting point to a pick-up location, a maximum walking distance from a drop-off location to a desired destination, a total maximum walking distance involved in a ride, a maximum number of subsequent pick-ups, maximum delay of arrival/detour incurred by subsequent pick-ups during a ride and a selection whether to permit toll road usage during the ride, etc.

Ride service parameters may be transmitted to server 150 for processing the request and assignment of an available vehicle based on the ride service parameters. For example, a ride request may be associated with a maximum walking distance of 300 meters from a starting point to a pick-up location. When assigning an available vehicle to pick up the user, server 150 may include in the assignment an assigned pick-up location within 300 meters or less of the starting point. Similarly, a ride request may be associated with a maximum walking distance of 0.5 mile from a drop-off location to a desired destination. When assigning an available vehicle to pick up the user, server 150 may include in the assignment an assigned drop-off location within 0.5 miles or less from the desired destination.

For requests associated with a maximum total walking distance of one mile during the ride, when assigning an available vehicle to pick up the user, server 150 may include in the assignment an assigned pick-up location and an assigned drop-off location, a total of a distance from the starting point to the assigned pick-up location and a distance from the assigned drop-off location to a desired destination may be equal to or less than one mile.

In the above examples, the values regarding the walking distances are only exemplary. Other embodiments consistent with the present disclosure may use different options of the distances and may provide a list of options. The distances may further be measured in different units, for example, miles, meters, kilometers, blocks, and feet, etc., which are not limited by the disclosed embodiments herein. In some embodiments, the distance may further be represented by an average walking time from a certain location to another, based on average walking speed, for example, ten minutes, five minutes, etc.

With respect to parameters regarding subsequent pick-ups, such as a maximum number of subsequent pick-ups, and maximum delay of arrival incurred by subsequent pick-ups, server 150 may assign subsequent pick-ups accordingly, without exceeding the parameters set by the user. For example, a ride request may be associated with a maximum number of two subsequent pick-ups during the ride. Server 150 may monitor the service status of the vehicle assigned to pick up the user, and refrain from assigning a third subsequent pick-up before the vehicle arrives at the drop-off location for dropping off the user. As another example, for a ride request associated with a maximum delay of arrival of ten minutes, when assigning subsequent ride requests, server 150 may calculate an estimated delay that may occur to the user if the same vehicle was to undertake the subsequent ride request. If the estimated delay that may occur to the user is more than ten minutes, server 150 may assign the subsequent ride request to other available vehicles.

In some embodiments, the user may also input selection of toll road usage through the associated user device to allow or disallow use of toll roads. Server 150 may then take the user's selection into account when assigning an available vehicle for accommodating the ride request, determining travel route, and calculating ride fare for the user. For example, server 150 may adjust the ride fare amount for a corresponding user based on the toll roads selection input and toll charges involved. For another example, if a first user does not permit toll road usage, before any subsequent pick-ups during the ride, server 150 may send a route to an assigned vehicle that does not include toll roads. For another example, if a subsequent user sharing the ride permits usage of toll road, server 150 may not charge the first user for any overlap portion of the ride where toll roads are used, change the route to include toll roads after the first user is dropped off, or assign the second user to a ridesharing vehicle with users that permit toll road usage.

In some embodiments, the ride request information may also be input from the driver device, for example, driver device 120D, or from a device associated with the vehicle. In the case of street hailing, where the user hails a vehicle on the street without using a vehicle ridesharing service application on a mobile communications device, the driver, for example, driver 130D, may input information such as the starting point/pick-up information and destination information through driver device 120D, which may then be transmitted to server 150.

At step 413, server 150 may calculate an estimated pick-up time, for example, based on a current location of an assigned vehicle and the first starting point included in the first ride request. An estimated pick-up time may refer to a time period before an assigned vehicle arrives at a pick-up location for picking up the user.

The assigned vehicle may refer to the vehicle that is assigned to undertake the first ride request, for example, a taxi in a taxi fleet, one of a plurality of vehicles managed by a transportation service system, or a plurality of vehicles owned by a plurality of owners and used to provide ridesharing services. The pick-up location may be the same as the starting point, or an assigned pick-up location associated with the starting point.

The estimated pick-up time may be determined based on a distance between a current location of the assigned vehicle and the pick-up location, and an estimate speed of traveling along the route between the two locations. The current location of the assigned vehicle may be determined by a location service application installed on a driver device, a driving-control device, or by a location determination component in the urban mobility management system 100, which may be a part of or separate from server 150. In some embodiments, the estimated pick-up time may further be determined based on historical or real-time traffic data, and a route currently followed by the vehicle.

In some embodiments, process 410 may further include locating one or a plurality of potential available vehicles, and selecting an assigned vehicle therefrom. For example, potential available vehicles may include vacant vehicles in the surrounding areas of the first starting point, and vehicles heading to a location close to the first starting point for assigned pick-ups or drop-offs. Server 150 may filter potential available vehicles by ride service parameters set by the users who are inside the vehicle, for example, removing occupied vehicles where a user inside the vehicle does not permit subsequent pick-ups, or occupied vehicles where the user requires a minimal delay. In some embodiments, server 150 may filter potential assignment vehicles by choosing a vehicle that would involve minimal walking of the user, or walking without the need of crossing the street. In some embodiments, server 150 may further filter potential assignment vehicles by choosing a vehicle that would involve minimal detour for the vehicle to arrive at the pick-up location. In some embodiments, the assigned vehicle may be selected by applying multiple filter criteria, or by applying multiple filter criteria in a certain order.

In some embodiments, the pick-up location may be an assigned pick-up location different from the first starting point, for example, half a block or further away from the first starting point. Server 150 may assign a pick-up location based on ride service parameters set by the first user, as described above at step 411. Server 150 may further assign a pick-up location which is along a main street where an assigned vehicle can easily locate, or a location which would not require an assign vehicle to take a U-turn. In cases where there are one or more other users in the vehicle, server 150 may assign a pick-up location close to the vehicle's next assigned drop-off, or on the side of a street where the vehicle will soon go through. In some embodiments, server 150 may adjust selection of the pick-up location based on filtering results of potential assignment vehicles, or vice versa. The two selection processes may complement each other to reach one or more optimal combinations.

In some embodiments, where there are multiple potential assignment vehicles, each with a corresponding potential pick-up location, an estimated pick-up time may be respectively calculated corresponding to each of the potential assignment vehicles. Server 150 may then choose the vehicle with the shortest estimated pick-up time to be the assigned vehicle.

At step 415, server 150 may send a first message to a user device associated with the first user, which is, in this example, user device 120A. The first message may be configured to cause an indication of the calculated first estimated pick-up time to appear on a display of user device 120A. The message may appear in different formats, for example, a text message including the estimated pick-up time, an audio message, or an image, the specific implementation of which are not limited by the disclosed embodiments herein.

In one embodiment, the message includes a confirmation that the ridesharing request is accepted. If server 150 assigns a pick-up location different from the starting point, the message may further cause the display of an indication of the assigned pick-up location. Server 150 may further provide a navigation option which may be displayed on a user interface. A selection of the navigation option may then provide walking directions the user to the assigned pick-up location for pick-up. The message may further cause a display of an indication of an estimated walking distance from the starting point to the assigned pick-up location. In addition, the message may include an estimated walking distance from the assigned drop-off location to the desired destination. The assigned drop-off location may be a location close to the desired destination, within the maximum walking distance parameters set by the first user. For example, the drop-off location may be at a location half a block away or further from the desired destination, and may be along a main street where the vehicle may easily locate and access. For another example, the drop-off location may be determined based on a route towards the next pick-up location, such that the vehicle may easily drop off the first user on its way to the next pick-up location, thereby avoiding an extra detour.

In another embodiment, the message may include one or more proposals associated with different vehicles. Each proposal may include information about the proposed pick-up location. The information about the proposed pick-up location may include the distance from the user to the proposed pick-up location. Each proposal may include a price of the ride associated with the type of the ride and an estimation of a pick-up time. The estimate may be presented as a range. In one example, each proposal may include different pick-up locations, different prices, and/or different estimations of a pick-up time. According to this embodiment, step 415 may also include receiving a proposal selection reflective of a selected pick-up vehicle and sending an addition message that includes information about the selected vehicle, and the driver associated with the vehicle. For example, the vehicle information may include the license plate number, brand, color, and/or model of the vehicle. The driver information may include a name, nickname, profile photo, ratings, number of previous rides, and/or contact information of the driver. The message may further include a contact option allowing the user to contact the driver, for example, a “contact the driver” button, which the user may select to initiate a communication session with the driver.

At step 417, server 150 may guide the assigned vehicle to the first pick-up location for picking up the first user. For example, server 150 may transmit direction information to the driver device associated with the assigned vehicle, for example, driver device 120D or driving-control device 120F. In some embodiments, a navigation component of the driver device, or the driving-control device may perform the step of guiding the vehicle to the first pick-up location. Correspondingly, server 150, or a navigation component of the user device 120A, may guide the user to the first pick-up location, in cases where the pick-up location is an assigned pick-location different from the first starting point. For example, for autonomous vehicles used for ridesharing services, such as autonomous vehicle 130F as shown in FIG. 1, the vehicle itself may be capable of using a variety of techniques to detect its surroundings, identify feasible paths, and navigate without direct human input.

In some embodiments, once the vehicle is assigned to pick up the user, server 150 may assign a communication channel for the driver associated with the assigned vehicle to communicate with the user, for example, a masked phone number. In some embodiments, a user interface of a driver device, such as driver device 120D, may include an option to send notification messages to the user, for example, a pre-defined message button of “I'm here.” Once the vehicle arrives at the pick-up location, the driver may click the message button to send the message to the user. This way, the driver may not need to dial out or type a message in order to notify the user of the vehicle's arrival, reducing driver distraction and associated safety hazards.

At step 419, server 150 may receive a second ride request from a second user. In some embodiments, the second user request may be a street hailing request received directly by the vehicle while the first user is still inside, namely, before dropping off the first user. The vehicle may then undertake the second ride request, if the first user permits subsequent pick-ups. In some embodiments, the driver of the vehicle may input the second ride request information through a driver device, for example, driver device 120D associated with driver 130D. The input may inform server 150 that the vehicle has undertaken a second ride request, or may further include the pick-up location and destination information of the second user. Server 150 may then accordingly determine whether to assign additional pick-ups to the same vehicle, and may further send direction information guiding the vehicle to the second user's destination.

In some embodiments, the second ride request may be received by server 150 from a second wireless mobile communications device, for example, user device 120B associated with user 130B as shown in FIG. 1. The second ride request may further include a second starting point, and a second desired destination. Server 150 may then assign a corresponding ride service to an available vehicle, which may be the vehicle that has picked up the first user, before dropping off the first user.

In processing the second ride request, the example process 420 as shown in FIG. 4B may be performed.

At step 422, server 150 may calculate a second estimated pick-up time, for example, based on a second current location of the vehicle and the second starting point. The second estimated pick-up time may refer to an estimated time period before the vehicle arrives at a second pick-up location for picking up the second user. The second pick-up location may be an assigned pick-up location different from, but associated with, the second starting point. Assignment of the second pick-up location may include similar steps as described above with reference to FIG. 4A, details of which are not repeated herein.

At step 424, server 150 may send a second message to the second wireless mobile communication device, which is user device 120B in this example. The second message may be configured to cause an indication of the calculated second estimated pick-up time to appear on a display of the second wireless mobile communication device. As described above with reference to FIG. 4A, the message may appear in different formats, and may further cause a display of multiple proposals with multiple options for the second pick-up location, walking distance, walking directions from the second starting point to the second pick-up location, etc., the details of which are not repeated herein.

In some embodiments, server 150 may set the second pick-up location at substantially the same location as the first pick-up location, for example, half a block away, or 100 meters away from the first pick-up location. This way, the vehicle may pick up both users at about the same time at substantially the same location, further improving service efficiency. In some embodiments, server 150 may set the second pick-up location at a substantially the same location as the first drop-off location, wherein the vehicle may drop off the first user, and pick up the second user at about the same time, without extra travelling. Further, in some embodiments, the second drop-off location may be set at substantially the same location as the first drop off location, such that the vehicle may drop off multiple users at the same time.

In some embodiments, server 150 may set the first pick-up location to substantially differ from the first starting point, and the second pick-up location to substantially differ from the second starting point, for example, to ensure both pick-up locations are along the same side of the same street where the vehicle may go through. Server 150 may then send respective directions to the first user device and the second user device to guide the users to the respective pick-up locations.

In some embodiments, server 150 may set the first pick-up location at substantially the same as the first starting point, and set the second pick-up location to substantially differ from the second starting point. For example, the selection of the pick-up locations may be made such that the first pick-up location and the second pick-up location are close to one another, both pick-up locations are along the same street, or the second pick-up location is close to the first drop-off location. Server 150 may then send respective directions to the first user device and the second user device to guide the users to the respective pick-up locations.

At step 426, server 150 may guide the vehicle to a second pick-up location for picking up the second user. As described above with reference to FIG. 4A, this step may also be performed by a navigation component of the driver's device (e.g., driver device 120D or driving-control device 120F associated with autonomous vehicle 130F).

In some embodiments, server 150 may change the first drop-off location after receiving the second ride request, and the change may be made without pre-approval of the first user. The first drop-off location refers to a location for dropping off the first user. As described above with reference to FIG. 4A, the first drop-off location may be the same as the first desired destination, or at a location different from the first desired destination.

For example, the second pick-up location may be set at a location close to the first desired destination, included in the first ride request. When assigning the second ride request to the vehicle, server 150 may change the first drop-off location to a location closer to or at the first desired destination, thus reducing the walking distance for the first user to arrive at his desired destination.

For another example, the first drop-off location may be changed to a location where the first user does not need to cross the street to arrive at his desired destination, without causing or increasing detour for the vehicle to arrive at the second pick-up location.

In some embodiments, urban mobility management system 100 may subsequently receive a plurality of subsequent ride requests. These additional ride requests may either be received by server 150 and assigned to the vehicles, or received by the vehicles in the form of street hailing. Steps described above with reference to FIGS. 4A and 4B may similarly be used to process the third ride request.

For example, server 150 may receive a third ride request from a third user device, for example, user device 120C associated with user 130C, as shown in FIG. 1. Server 150 may process the request and assign the request to the vehicle while at least one of a first user and a second user is still in the vehicle. The third ride request may further include a third starting point and a third desired destination. Server 150 may calculate a third estimated pick-up time, and send a confirmation to a user's device (e.g., user device 120C). Server 150 may transmit direction and route information to the driver's device associated with the vehicle (e.g., driver device 120D as shown in FIG. 1), to guide the vehicle to pick up and drop off user 130C.

As described above with reference to FIGS. 4A and 4B, processing of subsequent ride requests may take into account of the ride service parameters set by the users whose requests have previously been received and assigned. For example, if both the first user and the second user are still in the vehicle, and one of them has set a maximum delay of arrival, server 150 may not assign the third request to the same vehicle if such an assignment would cause a delay longer than the set value. For example, if the first user has set a maximum delay of arrival of 10 minutes, server 150 may calculate an estimated time period it takes for the vehicle to pick up (and/or drop off) the third user before dropping off the first user. If the estimated time would cause a total delay of arrival for the first user to exceed 10 minutes, server 150 may therefore assign the third ride request to another vehicle. For another example, if the second user has set a maximum number of one co-rider and the second user will be dropped off earlier than the first user, server 150 may not assign to the same vehicle, as such an assignment may cause violation of the parameter (maximum number of one co-rider) set by the second user.

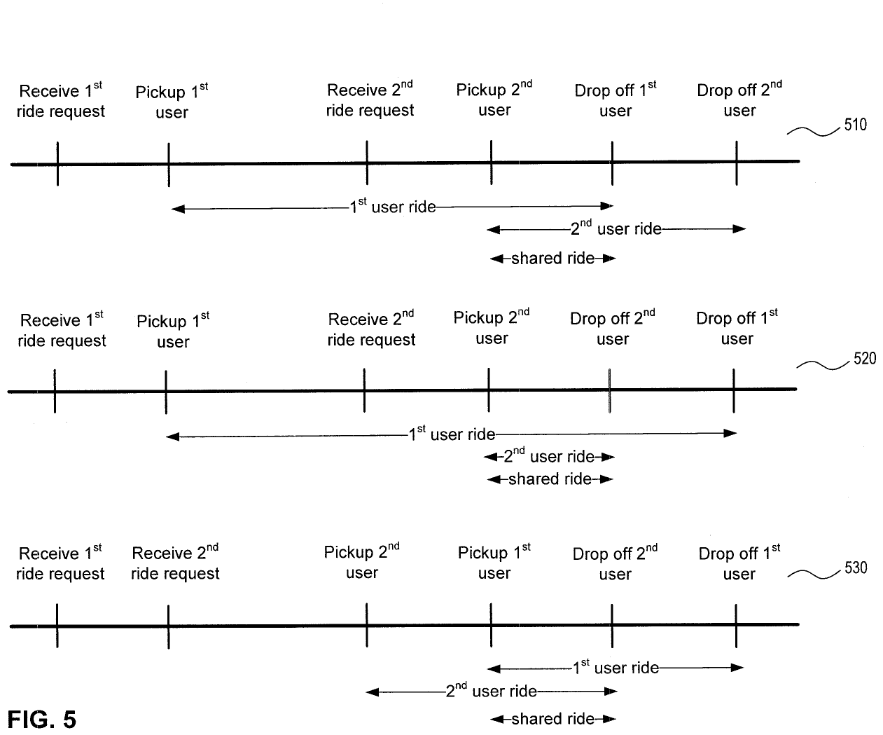

FIG. 5 is a diagram of three example timelines showing ridesharing arrangements, in accordance with some embodiments of the present disclosure. As shown in example timelines 510, 520, and 530, for a particular assigned vehicle undertaking a first ride request from a first user and a second ride request from a second user, the order of pick-ups and drop-offs for the second user may vary. For example, server 150 may receive a plurality of ride requests, design an optimal path and pick-up/drop-off order for a particular assigned vehicle undertaking multiple requests, and assign additional pick-ups as the vehicle completes a part of or all of the ride requests. For example, as shown in example timeline 510, a vehicle may receive a second ride request after picking up the first user, and drop off the first user before dropping off the second user. A corresponding shared ride portion may be the portion of ride between the pick-up of the second user and drop-off of the first user. As shown in example timeline 520, the vehicle may receive a second ride request after picking up the first user, and drop off the second user before dropping off the first user. A corresponding shared ride portion may be the portion of ride between the pick-up of the second user and drop-off the second user. As another example, as shown in example timeline 530, the vehicle may receive the first ride request and the second ride request before any pick-up. The vehicle may then pick up the second user before picking up the first user, and drop off the second user before dropping off the first user. A corresponding shared ride portion may be the portion of ride between pick-up of the first user and drop-off of the second user. Depending on the order of pick-ups and drop-offs, the server may then determine a corresponding shared ride portion, and calculate ride fare for each user based on, for example, the shared portion, solo portion of each user, and/or other factors such as the ride service parameters set by each user.

Consistent with the present disclosure, urban mobility management system 100 may complement the ridesharing service by offering a multi-leg transportation service that uses a fleet of personal transportation vehicles (e.g., scooters) and a fleet of multi-person transportation vehicles (e.g., ridesharing vans). The term “personal transportation vehicle” may refer to any type of pedal-driven vehicle or any type of motorized machine capable of transporting a user from one location to another location. In one embodiment, the personal transportation vehicle may be designed for transporting a single user weighing under 150 kg. For example, the personal transportation vehicle may be a scooter, electric bicycle, a motorized standing scooter, a personal transporter, an electric skateboard, and more. In one embodiment, a personal transportation vehicle may be a plug-in electric vehicle that includes one or more electric motors. In this embodiment, the electricity may be stored in a rechargeable battery on board the personal transportation vehicle. Urban mobility management system 100 may manage the charging schedule of the fleet of personal transportation vehicles using a plurality of charging stations.

Urban mobility management system 100 may determine one or more optional transportation routes for a user based on the user's ride request, location information associated with the fleet of personal transportation vehicles, and location information associated with the fleet of multi-person transportation vehicles. The term “determining a transportation route” may include determining a plan for transporting an object (e.g., a user or a personal transportation vehicle) from a starting point to a destination. When the determined transportation route is for a human user, the determined plan may include a walking segment to a location where the user will be picked up by a multi-person transportation vehicle and/or a walking segment to a location where the user can collect a personal transportation vehicle. When the determined transportation route is for an autonomous personal transportation vehicle, the determined plan may include a self-driving segment to a location where an autonomous personal transportation vehicle will be picked up by a multi-person transportation vehicle. In one example, the determined transportation route may include a segment where the user rides a personal transportation vehicle and a segment where the user rides a multi-person transportation vehicle together with other users.

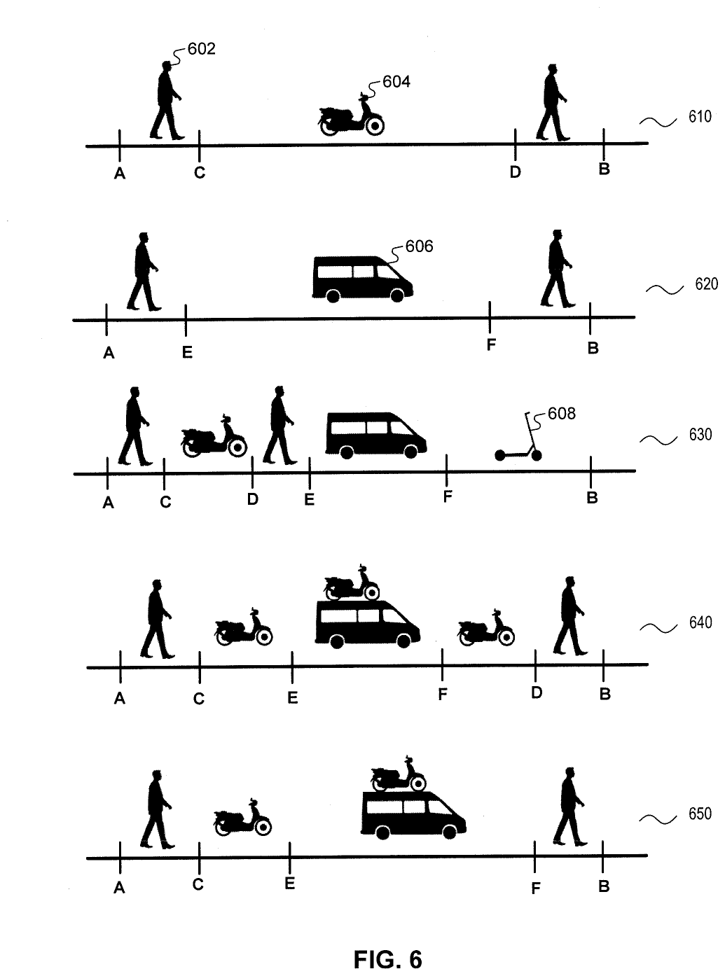

FIG. 6 is a diagram of five timelines illustrating different multi-leg optional transportation routes, consistent with embodiment of the present disclosure. The depicted multi-leg transportation optional transportation routes include at least one of: a segment where the user walks, a segment where the user rides a personal transportation vehicle, and a segment where the user rides a multi-person transportation vehicle together with other users. Each of the depicted timelines 610, 620, 630, 640, and 650, refer to a specific order of the different segments in the multi-leg optional transportation routes of a user 602. When determining optional transportation routes, urban mobility management system 100 may take into account the different speeds associated with each segment. For example, based on real-time traffic data, urban mobility management system 100 may determine that in some roads the average speed of riding a personal transportation vehicle may be greater than the average speed of riding a multi-person transportation vehicle. It will be appreciated, however, that other multi-leg transportation routes are possible and that urban mobility management system 100 may offer other variations of multi-leg transportation routes. It will also be readily appreciated that the discussed multi-leg transportation routes can be altered to modify the order of segments, avoid some segments, or include additional segments.

In the first multi-leg transportation route, as shown in example timeline 610, user 602 may request a ride from a starting point (point “A”) to a desired destination (point “B”). Urban mobility management system 100 may consider the real-time locations of the fleet of personal transportation vehicles and the real-time locations of the fleet of multi-person transportation vehicles and determine a first optional transportation route that may be associated with two segments of walking and one segment of riding a personal transportation vehicle. If the first optional transportation route would be selected, urban mobility management system 100 may instruct user 602 to a collection point (point “C”) where a selected personal transportation vehicle 604 is currently parked. Urban mobility management system 100 may also direct user 602 to travel with a personal transportation vehicle 604 to a parking point (point “D”) where personal transportation vehicle 604 may be parked. From the parking point, user 602 may walk to his desired destination. In one embodiment, the collection point may include a plurality of personal transportation vehicles 604 and user 602 may receive an indication which personal transportation vehicle 604 to take. Urban mobility management system 100 may select which personal transportation vehicle 604 to assign user 602 based on a current charge of each of the plurality of personal transportation vehicles in the collection point. In another embodiment, the parking point may include a charging station to charge personal transportation vehicles 604.

In the second multi-leg transportation route, as shown in example timeline 620, user 602 may request a ride from a starting point (point “A”) to a desired destination (point “B”). Urban mobility management system 100 may consider the real-time locations of the fleet of personal transportation vehicles and the real-time locations of the fleet of multi-person transportation vehicles and determine a second optional transportation route that may be associated with two segments of walking and one segment of riding a multi-person transportation vehicle. If the second optional transportation route would be selected, urban mobility management system 100 may instruct user 602 to a pick-up location (point “E”) where multi-person transportation vehicle 606 will pick-up user 602 and transport him to the drop-off location (point “F”). From the drop-off location, user 602 may walk to his desired destination. As discussed above, with reference to example timelines 510, 520, and 530, user 602 may share at least part of the ride in multi-person transportation vehicle 606 with at least one other passenger.

In the third multi-leg transportation route, as shown in example timeline 630, user 602 may request a ride from a starting point (point “A”) to a desired destination (point “B”). Urban mobility management system 100 may consider the real-time locations of the fleet of personal transportation vehicles and the real-time locations of the fleet of multi-person transportation vehicles, and determine a third optional transportation route that may be associated with two segments of walking, two segments of riding personal transportation vehicles, and one segment of riding a multi-person transportation vehicle. If the third optional transportation route would be selected, urban mobility management system 100 may instruct user 602 to a collection point (point “C”) where personal transportation vehicle 604 is currently parked. Urban mobility management system 100 may also direct user 602 to travel with personal transportation vehicle 604 to a parking point (point “D”) where personal transportation vehicle 604 may be parked. From the parking point, user 602 may walk to a pick-up location (point “E”). Multi-person transportation vehicle 606 may pick-up user 602 and transport him to the drop-off location (point “F”). From the drop-off location, user 602 may ride a personal transportation vehicle 608 to his desired destination. As discussed above, urban mobility management system 100 may determine the pick-up location and the drop-off location based on the desired destination of at least one other passenger in multi-person transportation vehicle 606. Consistent with the present disclosure, the distance that user 602 travels in multi-person transportation vehicle 606 may be at least three times longer, at least five time longer, at least ten times longer than the distance that user 602 travels in personal transportation vehicle 604 or personal transportation vehicle 608.

In the fourth multi-leg transportation route, as shown in example timeline 640, user 602 may request a ride from a starting point (point “A”) to a desired destination (point “B”). Urban mobility management system 100 may consider the real-time locations of the fleet of personal transportation vehicles and the real-time locations of the fleet of multi-person transportation vehicles and determine a fourth transportation route that includes two segments of walking, two segments of riding personal transportation vehicle 604, and one segment of riding multi-person transportation vehicle 606. If the fourth optional transportation route would be selected, urban mobility management system 100 may instruct user 602 to a collection point (point “C”) where personal transportation vehicle 604 is currently parked. Urban mobility management system 100 may also direct user 602 to travel with personal transportation vehicle 604 to a pick-up location (point “E”) where personal transportation vehicle 604 may be loaded into multi-person transportation vehicle 606. Multi-person transportation vehicle 606 may transport user 602 and personal transportation vehicle 604 to drop-off location (point “F”). From the drop-off location, user 602 may travel using personal transportation vehicle 604 to a parking point (point “D”) where user 602 may park personal transportation vehicle 604. From the parking point, user 602 may walk to his desired destination. Personal transportation vehicle 604 may be loaded to multi-person transportation vehicle 606 by any way known in the art. For example, personal transportation vehicle 604 may be loaded to multi-person transportation vehicle 606 using a device such as a bike rack or scooter carrier installed outside or inside multi-person transportation vehicle 606. In one embodiment, between point E to point F, multi-person transportation vehicle 606 may charge the battery of personal transportation vehicle 604.

In the fifth multi-leg transportation route, as shown in example timeline 650, user 602 may request a ride from a starting point (point “A”) to a desired destination (point “B”). Urban mobility management system 100 may consider the real-time locations of the fleet of personal transportation vehicles and the real-time locations of the fleet of multi-person transportation vehicles and determine a fifth optional transportation route that may be associated with two segments of walking, one segment of riding personal transportation vehicle 604, and one segment of riding multi-person transportation vehicle 606. If the fifth optional transportation route would be selected, urban mobility management system 100 may instruct user 602 to a collection point (point “C”) where personal transportation vehicle 604 is currently parked. Urban mobility management system 100 may also direct user 602 to travel with personal transportation vehicle 604 to a pick-up location (point “E”) where personal transportation vehicle 604 may be loaded into multi-person transportation vehicle 606. Multi-person transportation vehicle 606 may transport user 602 to drop-off location (point “F”). From the drop-off location, user 602 may walk to his desired destination. Personal transportation vehicle 604 may be dropped off at a location other than a location where user 602 was dropped off. In one embodiment, personal transportation vehicle 604 may be dropped off at a charging station. In another embodiment, personal transportation vehicle 604 may be dropped off at a location determined based on a predicted demand for personal transportation vehicles.

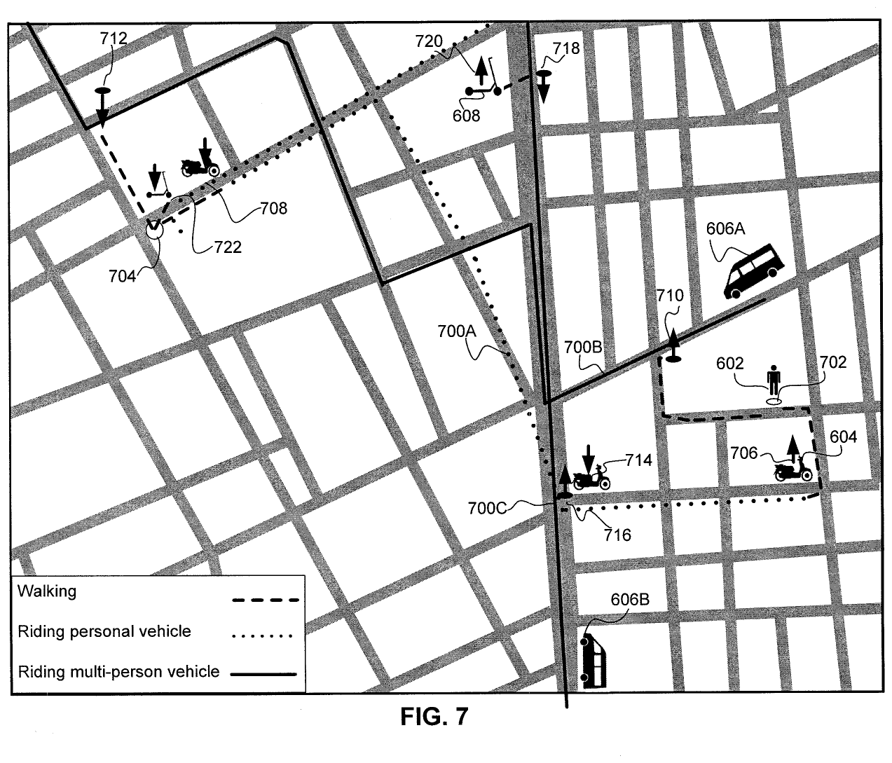

FIG. 7 illustrates three optional transportation routes 700 that urban mobility management system 100 determined for user 602 in response to the user's ride request. The user's ride request may be indicative of a starting point 702 and a desired destination 704. FIG. 7 illustrates a first optional transportation route 700A that corresponds with the multi-leg transportation route depicted in timeline 610, a second optional transportation route 700B that corresponds with the multi-leg transportation route depicted in timeline 620, and a third optional transportation route 700C that corresponds with the multi-leg transportation route depicted in timeline 630.

In first optional transportation route 700A, user 602 may pick up personal transportation vehicle 604 at a first collection point 706 and ride personal transportation vehicle 604 towards a parking point 708. From parking point 708 user 602 may walk to desired destination 704.

In second optional transportation route 700B, user 602 may be picked up by multi-person transportation vehicle 606A at a pick-up point 710 and be dropped off at a drop-off location 712. From drop-off location 712, user 602 may walk to desired destination 704. In third optional transportation route 700C, user may pick up personal transportation vehicle 604 at first collection point 706 and ride personal transportation vehicle 604 towards a parking point 714 that located next to a pick-up point 716. Multi-person transportation vehicle 606B may pick up user 602 at a pick-up point 716 and drop him at a drop-off location 718. Drop-off location 718 may be located next to a collection point 720 from which user 602 may collect personal transportation vehicle 608 and ride it to parking point 722 that is located next to desired destination 704.

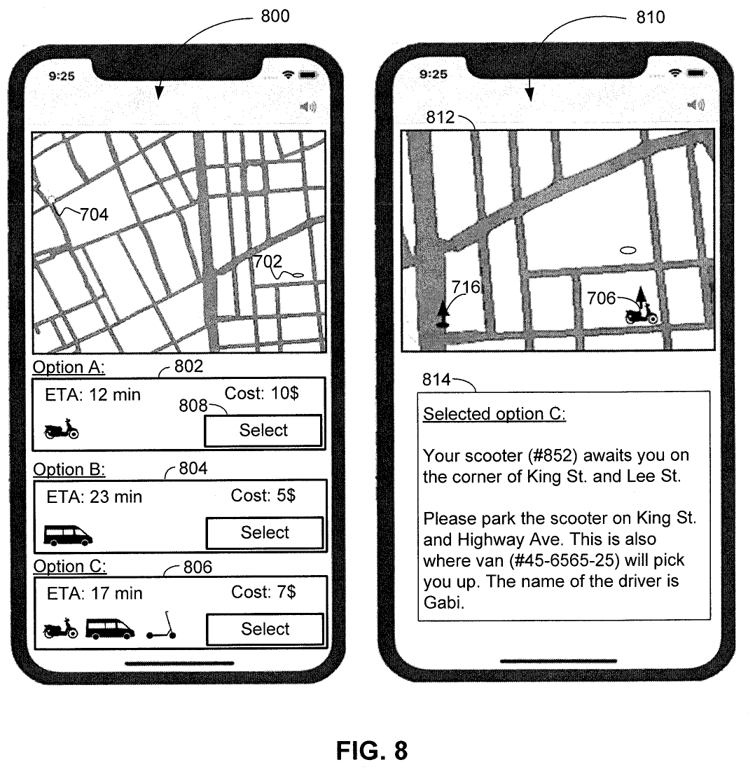

FIG. 8 depicts two screenshots illustrating an example graphical user interface (GUI) associated with an example mobility application for providing multiple transportation proposals to a user, according to embodiments of the present disclosure. The screenshots may be displayed on a communication device (e.g., mobile communications device 200) associated with user 602. In the illustrated example the screenshots may be displayed after user 602 made a ride request and provided input regarding starting point 702 and desired destination 704. Consistent with the example described above, urban mobility management system 100 may determine optional transportation routes 700A, 700B, and 700C based on the received ride request, the location information associated with the fleet of personal transportation vehicles, and the location information associated with the fleet of multi-person transportation vehicles. Screenshot 800 illustrates three transportation route proposals (802, 804, and 806) that urban mobility management system 100 provided to user 602. Specifically, in the illustrated example, first transportation route proposal 802 corresponds with optional transportation route 700A, second transportation route proposal 804 corresponds with second optional transportation route 700B, and third transportation route proposal 806 corresponds with third optional transportation route 700C. Each of the transportation route proposals may be associated with a selection button 808. User 602 may communicate with a server of urban mobility management system 100 through an input device (e.g., a keyboard, a touch screen, or microphone) associated with the communication device.

Consistent with the present disclosure, the provided transportation route proposals may differ from each other by at least one parameter. In one embodiment, each transportation route proposal may be associated with a differing estimated travel time (e.g., first transportation route proposal 802 may be associated with an estimated travel time of 12 minutes, second transportation route proposal 804 may be associated with an estimated travel time of 23 minutes, and third transportation route proposal 806 may be associated with an estimated travel time of 17 minutes). The travel time may be estimated based on real-time traffic conditions and different average travel speeds associated with the types of vehicle (e.g., even between personal transportation vehicle 604 and personal transportation vehicle 608 there may be differences in the average speed). In another embodiment, each transportation route proposal may be associated with a differing cost (e.g., first transportation route proposal 802 may be associated with a cost of $10, second transportation route proposal 804 may be associated with a cost of $5, and third transportation route proposal 806 may be associated with a cost of $7). The cost for each transportation route proposal may be determined based on the expected distance traveled using a personal transportation vehicle and the expected distance traveled using a multi-person transportation vehicle. In other embodiments, each transportation route proposal may be associated with a differing route distance, walking distance, waiting time, and other transportation parameters.

Consistent with the present disclosure, urban mobility management system 100 may provide user 602 with information about the selected transportation route. The information may include details about a collection point from which user 602 is scheduled to collect the assigned personal transportation vehicle and details about a pick-up location from which the assigned multi-person transportation vehicle is scheduled to pick up user 602. Screenshot 810 illustrates information that may be provided to user 602 in response to receipt from user 602 a proposal selection associated with third transportation route proposal 806. Specifically, the GUI of the example mobility application may include a map window 812 and a text window 814. In map window 812, the mobility application may depict the exact location of first collection point 706 from which user 602 can collect personal transportation vehicle 604 and the exact location of pick-up location 716 from which multi-person transportation vehicle 606B is scheduled to pick up user 602. In one embodiment, collection point 706 may include a plurality of personal transportation vehicles and the mobility application may provide an indication which personal transportation vehicle to take. For example, in text window 814, the mobility application may provide identifying details about the collection point and the pick-up location (e.g., address) and identifying details about the assigned personal transportation vehicle and the assigned multi-person transportation vehicle (e.g., plate number, driver name, and more details).

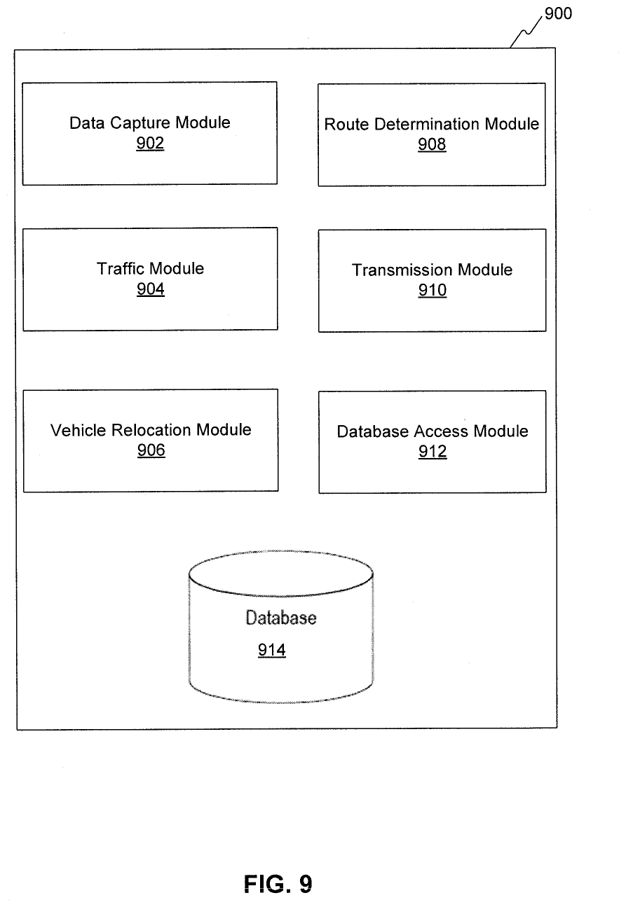

FIG. 9 illustrates an exemplary embodiment of a memory 900 containing software modules consistent with the present disclosure. In particular, as shown, memory 900 may include a data capture module 902, a traffic module 904, a vehicle relocation module 906, a route determination module 908, a transmission module 910, a database access module 912, and a database 914. Modules 902, 904, 906, 908, 910, and 912 may contain software instructions for execution by at least one processing device, e.g., processor 310, included with vehicle assignment system 300. Data capture module 902, traffic module 904, vehicle relocation module 906, route determination module 908, transmission module 910, database access module 912, and database 914 may cooperate to perform multiple operations. For example, data capture module 902 may receive a ride request from a user, receive indications of current locations of a plurality of multi-person transportation vehicles, and receive indications of current locations of a plurality of personal transportation vehicles. Traffic module 904 may receive real time traffic data and enables estimation of the durations of optional transportation routes for the user using a multi-person transportation vehicle and/or using a personal transportation vehicle. Vehicle relocation module 906 may determine a need for relocating a personal transportation vehicle. Route determination module 908 may determine a transportation route for the user based on the ride request; or a transportation route for the personal transportation vehicle based on the determined need. Transmission module 910 may use a communications interface for providing driving instructions to a multi-person transportation vehicle for transporting at least one user and/or for transporting at least one personal transportation vehicle. Database access module 912 may interact with database 914 which may store a plurality of rules for determining the transportation route and any other information associated with the functions of modules 902-912. The plurality of rules may include rules for determining if the user is permitted to ride the personal transportation vehicle. For example, confirming that the age of the user is above an age limit associated with the type of personal transportation vehicle.

In some embodiments, memory 900 may be included in, for example, memory 320. Alternatively or additionally, memory 900 may be stored in an external database 170 (which may also be internal to server 150) or external storage communicatively coupled with server 150, such as one or more database or memory accessible over network 140. Further, in other embodiments, the components of memory 900 may be distributed in more than one server.

In some embodiments, data capture module 902 may receive ride requests from a plurality of users, each ride request may include a starting point and a desired destination. A starting point may refer to a current location of the user, as input by each user through an input device of an associated communication device, or as determined by a location service application installed on the communication device. A desired destination may refer to a location where the user desires to be taken to, for example, an entrance of a shopping center. In some embodiments, data capture module 902 may also receive from a plurality of communication devices associated with a plurality of multi-person transportation vehicles (e.g., 606A and 606B) indications of current locations of the plurality of multi-person transportation vehicles. Additionally, data capture module 902 may also receive from a plurality of communication devices associated with a plurality of personal transportation vehicles (e.g., 604 and 608) indications of current locations of the plurality of personal transportation vehicles. The current location of the plurality of multi-person transportation vehicles and the plurality of personal transportation vehicles may be determined by a location service application installed on the communication devices, or by a location determination component in the urban mobility management system 100, which may be a part of or separate from server 150. For example, the location information may include global positioning system (GPS) data generated by at least one GPS component associated with each of the multi-person transportation vehicles and associated with each of the personal transportation vehicles.

In some embodiments, traffic module 904 may include instructions configured to receive historical and/or real time traffic data, including information about at least one of street blockages and atypical congestion. Traffic data may include real-time traffic data regarding a certain geographical region, and may be used to, for example, calculate estimated travel time in different optional transportation routes. Real-time traffic data may be received from a real-time traffic monitoring system, which may be integrated in or independent from urban mobility management system 100. In one embodiment, traffic module 904 may determine the real time traffic data from information received from the plurality of multi-person transportation vehicles. In some embodiments, traffic module 904 may also identify an existence of an area of traffic obstruction for a multi-person transportation vehicle in a vicinity of an optional transportation route and recommend using a personal transportation vehicle. Traffic obstructions may include scheduled event (e.g., a parade, an infrastructure repair, a construction work) and an unscheduled event (e.g., a road closure, an accident, a public safety incident, or any related environmental condition, such as a fallen tree or powerline). In another embodiment, traffic module 904 is configured to predict traffic conditions based on historic traffic data records.

In some embodiments, vehicle relocation module 906 identify a need for relocating one or more personal transportation vehicles to different locations. In one example, the identified need for relocating a specific personal transportation vehicle to a different location may be based on a determination that a specific personal transportation vehicle is in need of a battery charge. In another example, the identified need for relocating a specific personal transportation vehicle to a different location may be based on a determination that the specific personal transportation vehicle was parked in a prohibited location. In another example, the identified need for relocating a specific personal transportation vehicle to a different location may be based on received information on predicted environmental conditions. In another example, the identified need for relocating a specific personal transportation vehicle to a different location may be based on received input from a user about the specific personal transportation vehicle (e.g., a user may report that the personal transportation vehicle is broken and that it needs to get to the workshop).

In some embodiments, route determination module 908 may determine transportation routes. In a first aspect of the disclosure, route determination module 908 may determine transportation routes for a plurality of users. Specifically, according to the first aspect, route determination module 908 may determine transportation routes in response to ride requests received by data capture module 902. In a second aspect of the disclosure, route determination module 908 may determine transportation routes for a plurality of personal transportation vehicles. Specifically, according to the second aspect, route determination module 908 may determine transportation routes in response to a need identified by vehicle relocation module 906.

In the first aspect of the disclosure, the determined transportation route may include a first segment in which the user is scheduled to use a personal transportation vehicle and a second segment in which the user is scheduled to use the multi-person transportation vehicle. In a related embodiment, the determined transportation route may include a third segment between the first segment and the second segment in which the user is scheduled walk to at least 25 meters, at least 50 meters, at least 100 meters, at least 200 meters, at least 500 meters. In one example, the parking point of the personal transportation vehicle is in a walking distance from the pick-up location. In another example, the drop-off location is in a walking distance from the collection point. In addition, as illustrated in third optional transportation route 700C, the determined transportation route may include a first segment in which the user may be scheduled to use a first personal transportation vehicle, a second segment subsequent to the first segment in which the user may be scheduled to use the multi-person transportation vehicle, and a third segment subsequent the second segment in which the user may be scheduled to use a second personal transportation vehicle. Specifically, as illustrated in timeline 630, the user may use personal transportation vehicle 604 to get to the pick-up location and personal transportation vehicle 608 to get to the desired destination.

In another embodiment, the determined transportation route may include a first segment in which the user may be scheduled to use a personal transportation vehicle, a second segment subsequent to the first segment in which the user may be scheduled to use the multi-person transportation vehicle, and a third segment subsequent the second segment in which the user may be scheduled to use the personal transportation vehicle used in the first segment. Specifically, as illustrated in timeline 640, the user may use a personal transportation vehicle to get from the starting point to the pick-up location and the same personal transportation vehicle from the drop-off location to the desired destination. During the second segment, the multi-person transportation vehicle may transport both the user and the personal transportation vehicle to a same drop-off location. In another embodiment, route determination module 908 may determine the transportation route to answer identified need (e.g., charging need, predicted demand, and more). For example, the determined transportation route may include a parking point for the personal transportation vehicle at a location associated with a charging station for personal transportation vehicles. Specifically, the transportation route for the users may be based on previously collected battery data. In another embodiment, the determined transportation route may include a parking point for the personal transportation vehicle in a drop-off location of another user. For example, the user may be instructed to park the personal transportation vehicle and walk 500 meters to his/her desired destination because the same personal transportation vehicle is scheduled to be used by a different user.

In the second aspect of the disclosure, the determined transportation route for a personal transportation vehicle may include relocating the personal transportation vehicle by a multi-person transportation vehicle. In some cases, the determined transportation route for a personal transportation vehicle may include relocating the personal transportation vehicle by a user. Specifically, route determination module 908 may determine that a specific personal transportation vehicle (located in point “A”) should be relocated to an area associated with a predicted demand (in proximity to point “B”). In the simple use case, a multi-person transportation vehicle may take the specific personal transportation vehicle from point “A” to point “B.” But, in a more complex use case, a user may take the specific personal transportation vehicle from point “A” to point “C,” and a multi-person transportation vehicle may then take the specific personal transportation vehicle from point “C” to point “B.” In one embodiment, route determination module 908 may determine a pick-up location for at least one user based on a desired destination of a specific personal transportation vehicle. For example, a pick-up location of a certain user may be selected as the drop-off location of a personal transportation vehicle. In another embodiment, route determination module 908 may determine a drop-off location for at least one user based on a desired destination of a specific personal transportation vehicle. For example, a drop-off location of a certain user may be selected as the drop-off location of a personal transportation vehicle. In another embodiment, route determination module 908 may determine the drop-off location for the at least one user after the multi-person transportation vehicle was allocated to transport a personal transportation vehicle and while the at least one user is riding the multi-person transportation vehicle. In other words, drop-off locations of users may change during the users' ride based on a determined task to transport a personal transportation vehicle. For example, a drop-off location of a user may change due to an identified need to pick-up a personal transportation vehicle from a specific location.

In some embodiments, transmission module 910 may communicate with server 150 to send, via a communications interface, information associated with the determined transportation route. As discussed above, communications interface 360 may include a modem, Ethernet card, or any other interface configured to exchange data with a network, such as network 140 in FIG. 1. For example, server 150 may include software that, when executed by a processor, provides communications with network 140 through communications interface 360 to one or more mobile communications devices 120A-F. In some embodiments, transmission module 910 may provide driving directions to an assigned multi-person transportation vehicle. In other embodiments, transmission module 910 may provide the user with information about the determined transportation route. The information about the determined transportation route may include walking directions. For example, the information may include walking directions from a starting point to a collection point.

In some embodiments, database access module 912 may cooperate with database 914 to retrieve a plurality of rules for determining transportation routes, map information, traffic data, environmental condition data, and/or any associated stored data or metadata. For example, database access module 912 may send a database query to database 914 which may be associated with database 170. Database 914 may be configured to store any type of information to be used by modules 902-912, depending on implementation-specific considerations. For example, route determination module 908 is configured to determine a route for the multi-person transportation vehicle using a plurality of rules stored in database 914. Route determination module 908 may further be configured to determine the driving route for the multi-person transportation vehicle using data stored in database 914. The stored data may be prior-collected information. Prior-collected information may include ride request information from users received from data capture module 902. Prior-collected information may also include indications of locations of the plurality of multi-person transportation vehicles and the plurality of personal transportation vehicles received from data capture module 902. Prior-collected information may also include received real time traffic data and information providing a description of the nature, time, and/or date of any traffic conditions and/or environmental conditions received from traffic module 904.

In some embodiments, database 914 may include separate databases, including, for example, a vector database, raster database, tile database, viewport database, and/or a user input database, configured to store data. The data stored in database 914 may be received from modules 902-912, server 150, from communications devices 120A-G and/or may be provided as input using data entry, data transfer, or data uploading. The data stored in the database 914 may represent multiple data forms including, for example, general mapping and geographic information, latitude and longitude (Lat/Lon) values, world coordinates, tile coordinates, pixel coordinates, Mercator and/or other map projection data, user identifier data, driver identifier data, vehicle identifier data, device type data, viewport data, device orientation data, user input data, geographical scale data, and a variety of other electronic data. Database 914 may also include, for example, street, city, state, and country data including landmark identifiers and other related information. Database 914 may also include search logs, cookies, web pages, and/or social network content, etc.

Modules 902-912 may be implemented in software, hardware, firmware, a mix of any of those, or the like. For example, if the modules are implemented in software, the modules may be stored in a server (e.g., server 150) or distributed over a plurality of servers. Processing devices of server 150 may be configured to execute the instructions of modules 902-912. In some embodiments, aspects of modules 902-912 may include software, hardware, or firmware instructions (or a combination thereof) executable by one or more processors, alone or in various combinations with each other. For example, modules 902-912 may be configured to interact with each other and/or other modules of server 150 and/or urban mobility management system 100 to perform functions consistent with disclosed embodiments.

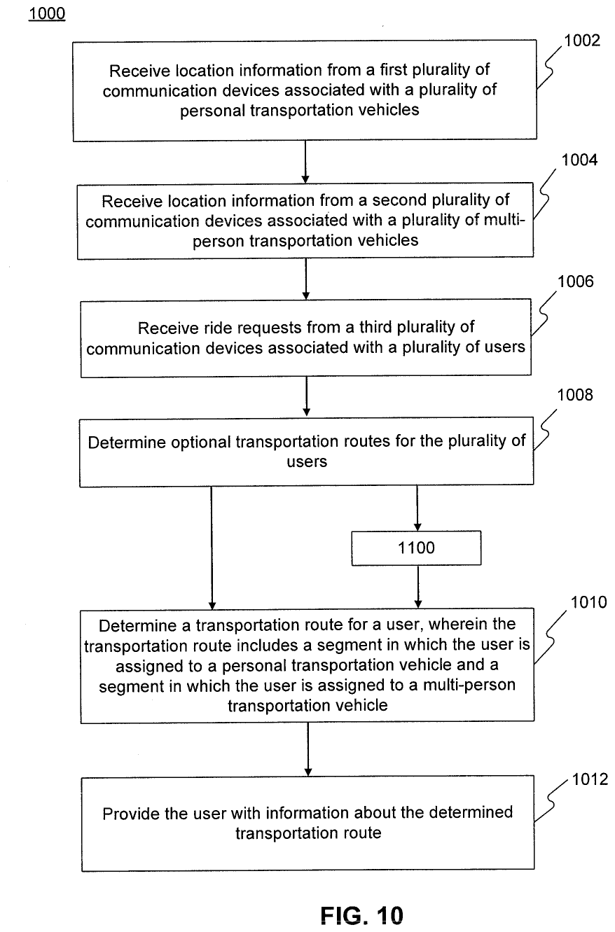

FIG. 10 is a flowchart of an example method 1000 for providing transportation executed by a processing device of urban mobility management system 100, according to embodiments of the present disclosure. For the purposes of illustration, in the following description reference is made to certain components of urban mobility management system 100. It will be appreciated, however, that other implementations are possible and that any combination of components or devices may be utilized to implement the exemplary method. It will also be readily appreciated that the illustrated method can be altered to modify the order of steps, delete steps, or further include additional steps.

At step 1002, a processing device (e.g., processor 310) may receive location information from a first plurality of communication devices (e.g., communication device 120G) associated with a plurality of personal transportation vehicles (e.g., personal transportation vehicle 130G). The location information associated with the plurality of personal transportation vehicles may be used by the processing device to determine optional transportation routes for users. In one embodiment, the plurality of personal transportation vehicles may include at least one motorized vehicle capable of transporting a user (e.g., user 602) from a collection point (e.g., collection point 706) to a parking point (e.g., parking point 708). The plurality of personal transportation vehicles may also include at least one autonomous personal transportation vehicle and/or at least one manually driven personal transportation vehicle. Typically, the plurality of personal transportation vehicles may be manually operated, and the processing device may determine optional transportation routes for the user by confirming that the user can operate the assigned personal transportation vehicle. In one example, the processing device may check that the age of the user is above an age limit associated with the type of personal transportation vehicle. In another example, the processing device may access a database to confirm that the user is permitted to use the personal transportation vehicle (e.g., registered to service, has license, etc.). In some embodiments, when the plurality of personal transportation vehicles may be electrically powered, the processing device may receive reports indicative of battery data from the personal transportation vehicles. The received reports may be used to identify which personal transportation vehicles are available for the user and which optional transportation routes are feasible.

At step 1004, the processing device may receive location information from a second plurality of communication devices (e.g., communication device 120D, 120E, 120F) associated with a plurality of multi-person transportation vehicles (e.g., multi-person transportation vehicle 606).

The plurality of multi-person transportation vehicles may include vehicles capable of transporting at least two passengers at a same time, transporting at least four passengers at a same time, transporting at least six passengers at a same time, or transporting at least eight passengers at a same time. The plurality of multi-person transportation vehicles may also include vehicles capable of transporting at least one personal transportation vehicle while transporting at least one passenger, transporting at least two personal transportation vehicles while transporting at least two passengers, or transporting at least five personal transportation vehicles at a same time. The plurality of multi-person transportation vehicles may also include at least one autonomous vehicle (e.g., autonomous vehicle 130F) and/or at least one manually driven vehicle. The location information associated with the plurality of multi-person transportation vehicles may be used by the processing device to determine optional transportation routes for users. In some embodiments, the plurality of multi-person transportation vehicles may include ridesharing vehicles, and the processing device may determine optional transportation routes for the user by considering desired destinations of other users currently assigned to the plurality of multi-person transportation vehicles. For example, determining optional transportation route may include determining at least one collection point and/or at least pick-up location. A collection point and/or a pick-up location for a first user may be determined based on a desired destination of a second user. Additionally, the processing device may determine optional transportation routes for the user by considering tasks assigned to the plurality of multi-person transportation vehicles, such as, driver scheduled brakes, need for recharging, etc.

At step 1006, the processing device may receive ride requests from a third plurality of communication devices associated with a plurality of users. As mentioned above, each ride request may include a starting point and a desired destination. In one embodiment, the starting point may refer to a current location of the user. Alternatively, users may request pre-scheduled rides from locations other than their current locations. The pre-scheduled ride requests may include a requested pick-up time in addition to the starting point and the desired destination. The requested pick-up time may be at least one hour, at least two hours, or at least four hours after a time the ride request is received. Additionally, a rider may preschedule a specific journey in advance, that is the user may request a journey now, in two hours, in 3 weeks, or recurring rides for the next 3 months. For example, a user may ask that next Monday at 8:00 AM she will have a personal transportation vehicle waiting for her (e.g., within 5 minutes of walking from her home). The exact location of the personal transportation vehicle may be provided to her between 5 to 60 minutes before 8:00 AM.

At step 1008, the processing device may determine optional transportation routes for the plurality of users. The processing device may determine optional transportation routes for a specific user by considering scheduled pick-up locations of other users assigned to the multi-person transportation vehicle that may be assigned to the specific user. For example, a parking point in an optional transportation route for a first user may be determined based on a pick-up location or a drop-off location of a second user. In addition, the processing device may determine optional transportation routes for users by considering map data indicative of roads prohibited to personal transportation vehicles and/or roads prohibited to multi-person transportation vehicles. Specifically, some roads may also be open to personal transportation vehicles and not multi-person transportation vehicles (e.g., a pedestrian mall, bike lanes). The map data may also include details about the average speeds associated with each road at this time for walking, riding a personal transportation, or riding a multi-person transportation vehicle. For example, the average speed of riding a personal transportation vehicle in certain roads in certain hours may be greater than the average speed of riding a multi-person transportation vehicle. The processing device may take into consideration the estimated average speed to determine the optional transportation routes. In one embodiment, the processing device may provide the user with a proposal including a first optional transportation route and a second optional transportation route. The first optional transportation route may be different from the second optional transportation route in at least one aspect. For example, the first optional transportation route may be associated with a first collection point located in a different location than a second collection point of the second optional transportation route. The processing device may receive data indicative of a user selection of the first optional transportation route, and to select the transportation route for the user based on the user selection. Additional details about this embodiment is provided below with reference to method 1100.

At step 1010, the processing device may determine a transportation route for a user, wherein the transportation route includes a segment in which the user is assigned to a personal transportation vehicle and a segment in which the user is assigned to a multi-person transportation vehicle. In one embodiment, method 1100 takes place prior to step 1010 and the determination of the transportation route for the user is based on a user selection of a transportation route proposal. In another embodiment, the processing device may receive information about traffic conditions in a geographical area associated with the plurality of ride requests, and the determination of the transportation route for the user may be based on predicted and/or real-time traffic conditions. The information about the traffic conditions may affect the route determination in several ways. First in determining the optional transportation routes for a user, the processing device may avoid selecting roads with predicted high traffic. Second, even after a transportation route was determined, the processing device may determine changes to the transportation route based on real-time traffic conditions. For example, in order to avoid having the user sits in traffic, the processing may drop the user before the area with high traffic and assign him to a personal transportation vehicle for the rest of his journey. Additionally, the processing device may receive information about environmental conditions in a geographical area associated with the plurality of ride requests, and the determination of the transportation route for the user may be based on the predicted and/or real-time environmental conditions. In one embodiment, rain may affect the duration of the travel in a personal transportation vehicle. For example, the processing device may decide to limit the expected duration or even avoid using a personal transportation vehicle due to the rain.

At step 1012, the processing device may provide the user with information about the determined transportation route. The information about the determined transportation route may include details indicative of an estimated time of arrival to the user's desired destination when following the determined transportation route. In one case, the determined transportation route may include at least one segment of riding a personal transportation vehicle and at least one segment of riding a multi-person transportation vehicle. In this case, the information provided to the user may include details about a collection point from which the user is scheduled to collect the assigned personal transportation vehicle and details about a pick-up location from which the assigned multi-person transportation vehicle is scheduled to pick up the user. In another case, the information provided about the transportation route may include instructions to transport the personal transportation vehicle using the multi-person transportation vehicle. For example, a user may use the personal transportation vehicle after being dropped off by the multi-person transportation vehicle (e.g., timeline 640) or the multi-person transportation vehicle may be scheduled to take the personal transportation vehicle to a charging point (e.g., timeline 650).

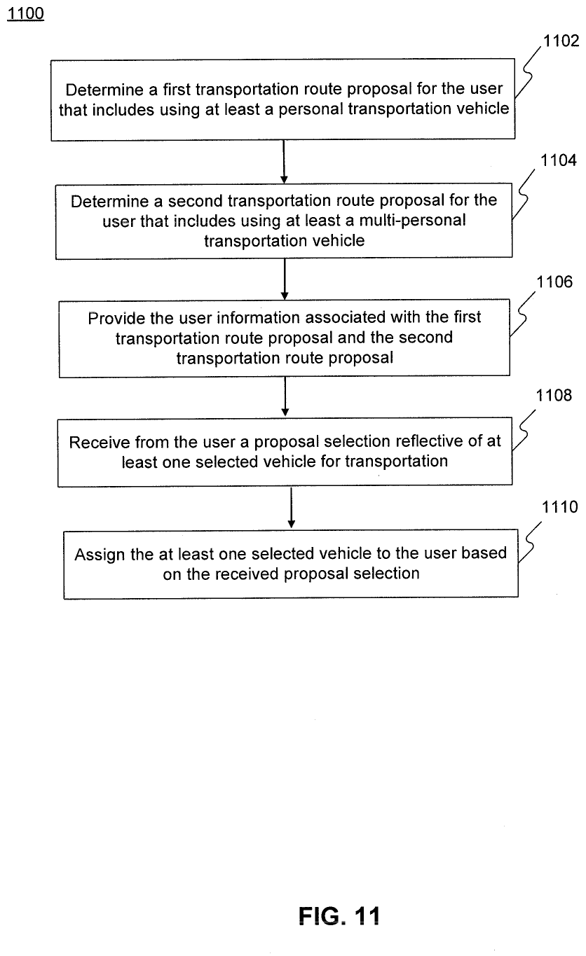

FIG. 11 is a flowchart of an example method 1100 for providing multiple transportation proposals to a user executed by a processing device of urban mobility management system 100, according to embodiments of the present disclosure. For the purposes of illustration, in the following description reference is made to certain components of urban mobility management system 100. It will be appreciated, however, that other implementations are possible and that any combination of components or devices may be utilized to implement the exemplary method. It will also be readily appreciated that the illustrated method can be altered to modify the order of steps, delete steps, or further include additional steps.

At step 1102, a processing device (e.g., processor 310) may determine a first transportation route proposal for the user that includes using at least a personal transportation vehicle. Consistent with the present disclosure, every transportation route proposal may involve the user walking from one point to another. For example, the user will be instructed to walk from a starting point 702 to collection point 706. In one embodiment, the first transportation route proposal may include a single segment in which the user is assigned to a single personal transportation vehicle (e.g., first transportation route proposal 802). In a second embodiment, the first transportation route proposal may include multiple segments in which the user is assigned to a plurality of personal transportation vehicles (e.g., third transportation route proposal 806). In a third embodiment, the first transportation route proposal may include a first segment in which the user is assigned to a personal transportation vehicle and a second segment in which the user is assigned to a multi-person transportation (e.g., third transportation route proposal 806).

At step 1104, the processing device may determine a second transportation route proposal for the user that includes using at least a multi-personal transportation vehicle. In one embodiment, the second transportation route proposal may include a single segment in which the user is assigned to a single multi-personal transportation vehicle (e.g., second transportation route proposal 804). In a second embodiment, the second transportation route proposal may include multiple segments in which the user is assigned to a plurality of multi-personal transportation vehicles (e.g., in long distance rides). In a third embodiment, the second transportation route proposal may include a first segment in which the user is assigned to a personal transportation vehicle and a second segment in which the user is assigned to a multi-person transportation (e.g., third transportation route proposal 806).

At step 1106, the processing device may provide the user information associated with the first transportation route proposal and the second transportation route proposal. In some cases, the first transportation route may include a segment in which the user is assigned to a first personal transportation vehicle and a segment in which the user is assigned to a first multi-person transportation vehicle, and the second transportation route may include a segment in which the user is assigned to a second personal transportation vehicle and a segment in which the user is assigned to a second multi-person transportation vehicle. Consistent with the present disclosure, the information provided to the user may include estimated time of arrival for each of the first transportation route proposal and the second transportation route proposal. The processing device may provide additional information about the first transportation route proposal and the second transportation route proposal. The additional information may include the overall walking distance, the walking distance for each segment, the type of vehicle assigned to the user in each segment, the number of other passengers in a multi-person transportation vehicle, the estimated waiting time at a pick-up location, identifying details on assigned vehicle, and more particulars that distinguish between the transportation route proposals. In one embodiment, the additional information is provided upon receiving input from the user. The input may be a request for additional information or a selection of one of the transportation route proposals.

At step 1108, the processing device may receive from the user a proposal selection reflective of at least one selected vehicle for transportation, and at step 1110, the processing device may assign the at least one selected vehicle to the user based on the received proposal selection. Consistent with the present disclosure, when the user selects the first transportation route proposal, the processing device may provide the user with information about a collection point from which the user can collect the personal transportation vehicle, and when the user selects the second transportation route proposal, the processing device may provide the user with information about a pick-up location from which the multi-person transportation vehicle is scheduled to pick up the user.

In one embodiment, the user may need to make a proposal selection within a predefined period of time (e.g., thirty seconds, two minutes). If the predefined period of time passed, the processing will need to start method 1100 to determine new transportation route proposals.

The discussion above described in detail the different options of transportation available to a user when vehicle assignment system 300 can assign both a personal transportation device and a multi-person transportation vehicle. A person skilled in the art would recognize that urban mobility management system 100 may similarly determine a plurality of transportation routes for a plurality of users. The plurality of transportation routes may include at least one route in which a user among the plurality of users uses a personal transportation vehicle from the fleet of personal transportation vehicles and at least one route in which another user among the plurality of users uses a multi-person transportation vehicle from the fleet of plurality of multi-transportation vehicles.

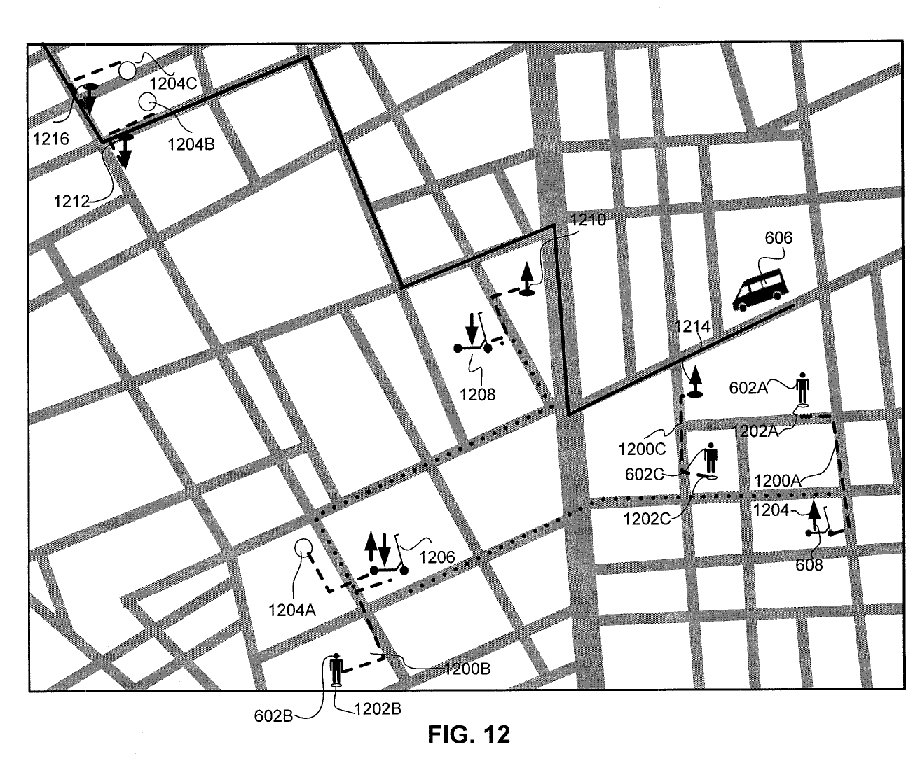

FIG. 12 illustrates three transportation routes 1200 that urban mobility management system 100 determined for users 602 in response to the users' ride requests. The ride request of user 602A may be indicative of a starting point 1202A and a desired destination 1204A, the ride request of user 602B may be indicative of a starting point 1202B and a desired destination 1204B, and ride request of user 602C may be indicative of a starting point 1202C and a desired destination 1204C.

In the example illustrated in FIG. 12, urban mobility management system 100 may assign only a personal transportation device to user 602A, assign a personal transportation device and a multi-person transportation vehicle to user 602B, and assign only a multi-person transportation vehicle to user 602C. As illustrated, urban mobility management system 100 may coordinate the usage of its vehicles by determining transportation routes that optimize the overall transportation service. Specifically, transportation route 1200A includes a first segment where user 602A walks to collection point 1204, a second segment where user 602A rides personal transportation vehicle 608 to parking point 1206, and a third segment where user 602A walks to desired destination 1204A. Transportation route 1200B includes a first segment where user 602B walks to a collection point (parking point 1206) to pick up personal transportation vehicle 608 that user 602A used, a second segment where user 602B rides personal transportation vehicle 608 to parking point 1208, a fourth segment where user 602B walks to pick-up location 1210, a fifth segment where user 602B rides multi-person transportation vehicle 606 to drop-off location 1212, and a sixth segment where user 602B walks to desired destination 1204B. Transportation route 1200C includes a first segment where user 602C walks to pick-up location 1214, a second segment where user 602C rides multi-person transportation vehicle 606 to drop-off location 1216, and a third segment where user 602C walks to desired destination 1204C.

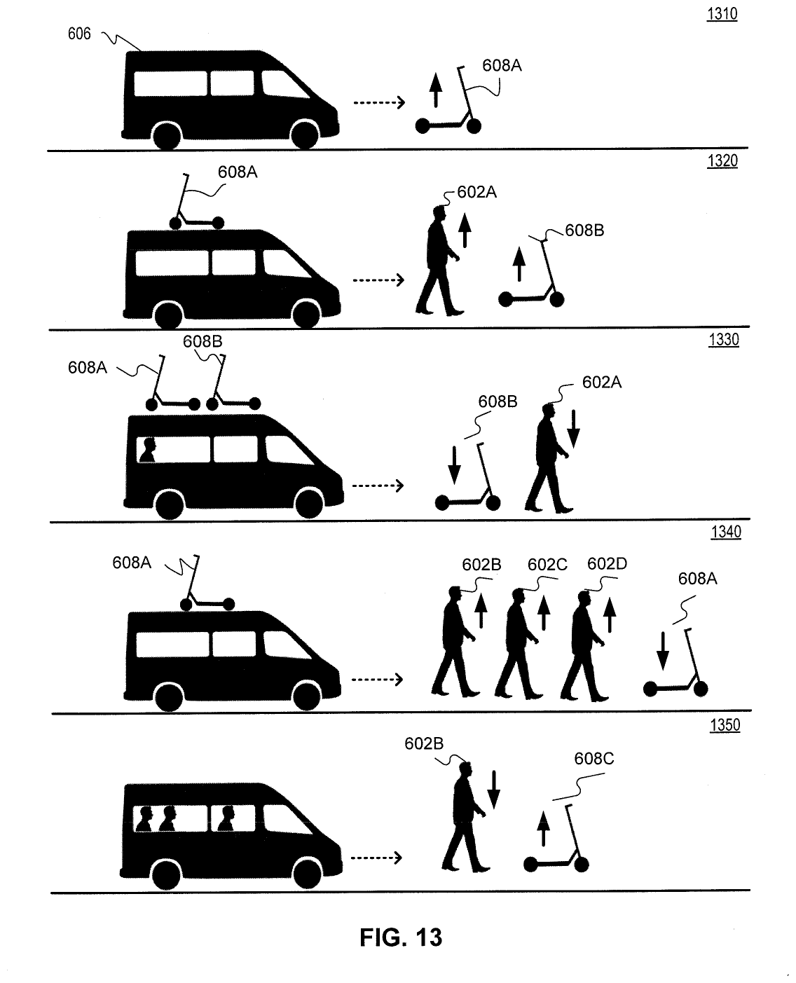

Consistent with the present disclosure, urban mobility management system 100 may identify a need for relocating a plurality of personal transportation vehicles to different locations. Based on the identified need, urban mobility management system 100 may instruct one or more multi-person transportation vehicles to relocate the plurality of personal transportation vehicles. FIG. 13 is a diagram illustrating a journey of a multi-person transportation vehicle 606. In some embodiments, urban mobility management system 100 may receive updates from a fleet of personal transportation vehicles 608 in addition to the ride requests received from a plurality of users 602. The updates may include location information (e.g., data generated by at least one GPS component associated with each personal transportation vehicle 608) and/or battery charge status (e.g., in cases when the personal transportation vehicles are electrically powered). The illustrated journey of multi-person transportation vehicle 606 includes five parts. Each part is associated with a stop in which at least one user and/or at least one personal transportation vehicle is being picked up or being dropped off. It will be appreciated that other combinations of picking up/dropping off users and personal transportation vehicles are possible. It will also be readily appreciated that the discussed journey of multi-person transportation vehicle 606 can be modify according to identified real-time events.

The first part 1310 of the journey starts when multi-person transportation vehicle 606 is empty. Urban mobility management system 100 may identify that a personal transportation vehicle 608A should be moved from its current location, and direct empty multi-person transportation vehicle 606 to pick up personal transportation vehicle 608A. In one embodiment, urban mobility management system 100 may identify a need for relocating personal transportation vehicle 608A based on a current location of the personal transportation vehicle 608A and a predicted demand for personal transportation vehicles (e.g., personal transportation vehicle 608A may have been located in area with low demand). In one embodiment, when personal transportation vehicle 608A is loaded to multi-person transportation vehicle 606, urban mobility management system 100 already determined its drop-off location. In another embodiment, the drop-off location of personal transportation vehicle 608A may be determined after at least one passenger is picked up by multi-person transportation vehicle 606. Urban mobility management system 100 may prioritize empty multi-person transportation vehicles for relocating personal transportation vehicles over multi-person transportation vehicles that currently transport users.

The second part 1320 of the journey starts when personal transportation vehicle 608A is already loaded in multi-person transportation vehicle 606. Urban mobility management system 100 may direct multi-person transportation vehicle 606 to pick up a user 602A and a personal transportation vehicle 608B. In a first embodiment, user 602A may rode personal transportation vehicle 608B to arrive to the pick-up location. In a second embodiment, urban mobility management system 100 may identify a need for recharging personal transportation vehicle 608B based on current battery-charge data associated with personal transportation vehicle 608B. Consistent with the present disclosure, urban mobility management system 100 may determine the pick-up location for user 602A based on a current location of personal transportation vehicle 608B.

The third part 1330 of the journey starts when multi-person transportation vehicle 606 carries personal transportation vehicle 608A, personal transportation vehicle 608B, and user 602A. Urban mobility management system 100 may direct multi-person transportation vehicle 606 to drop off user 602A and personal transportation vehicle 608B. In a first embodiment, user 602A may be assigned to ride personal transportation vehicle 608B to his desired destination. In a second embodiment, when personal transportation vehicle 608B is in need for a recharge, the driver of multi-person transportation vehicle 606 may plug-in personal transportation vehicle 608B to a charging station. Consistent with the present disclosure, urban mobility management system 100 may direct multi-person transportation vehicle 606 to drop off user 602A at a location in proximity to a charging station. Moreover, urban mobility management system 100 may receive availability data associated with charging stations for personal transportation vehicles, and to determine the drop-off location of user 602A based on a location of an available charging station.

The fourth part 1340 of the journey starts when personal transportation vehicle 608A is still loaded in multi-person transportation vehicle 606. Urban mobility management system 100 may direct multi-person transportation vehicle 606 to pick up users 602B, 602C, and 602D and to unload personal transportation vehicle 608A. Consistent with the present disclosure, the driver of multi-person transportation vehicle 606 may unload personal transportation vehicle 608A while users 602B, 602C, and 602D are entering multi-person transportation vehicle 606. Urban mobility management system 100 may decide to locate personal transportation vehicle 608A at the pick-up location of users 602B, 602C, and 602D even when there is no immediate demand at that location. The decision may be based on predicted demand and current locations of other personal transportation vehicles.

The fifth part 1350 of the journey starts when multi-person transportation vehicle 606 carries users 602B, 602C, and 602D. Urban mobility management system 100 may direct multi-person transportation vehicle 606 to drop off user 602B and to pick up personal transportation vehicle 608C. In one embodiment, urban mobility management system 100 may determine to pick up personal transportation vehicle 608C because the multi-leg transportation route of user 602C includes a segment of traveling using a personal transportation vehicle to his desired destination. Consistent with the present disclosure, urban mobility management system 100 may determine the drop-off location of user 602B based on a location of personal transportation vehicle 608C.

As mentioned above, urban mobility management system 100 may identify a need for relocating a plurality of personal transportation vehicles to different locations. Based on the identified need, urban mobility management system 100 may determine a plurality of transport tasks for the plurality of personal transportation vehicles. The transport tasks for the personal transportation vehicles may serve a similar function as the ride requests for the users. Each transport task may include a starting point indicating where a corresponding personal transportation vehicle currently parks and a desired destination associated with the identified need for the corresponding personal transportation vehicle. Thereafter, urban mobility management system 100 may determine transportation routes for the plurality of personal transportation vehicles based on the transport tasks.

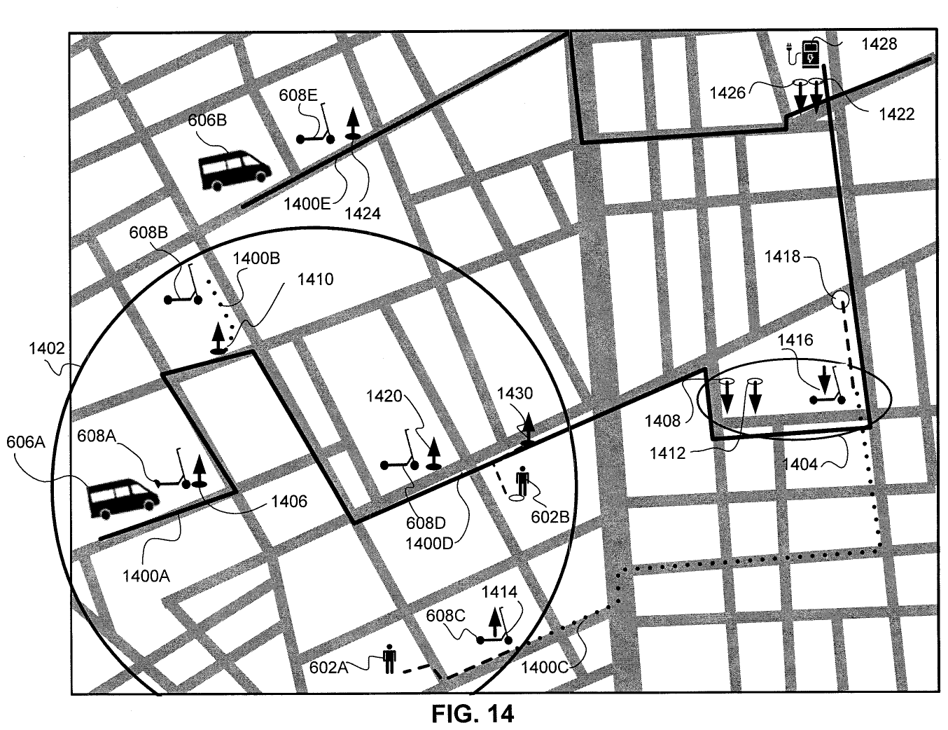

The determined transportation routes include at least one route in which one of the plurality of personal transportation vehicles is relocated by one of the plurality of multi-person transportation vehicles. In one embodiment, where a personal transportation vehicle has autonomous driving capabilities, the determined transportation routes may include a segment where the personal transportation vehicles drive itself to a pick-up location. The following discussion with reference to FIG. 14 describes transportation routes for a first plurality of personal transportation vehicles associated with a need for answering a predicted demand, and transportation routes for a second plurality of personal transportation vehicles associated with a need for recharge. The present invention is not limited to the type of need for relocating a plurality of personal transportation vehicles.

FIG. 14 illustrates a plurality of transportation routes 1400 that urban mobility management system 100 determined for personal transportation vehicles 608 in response to an identified need. Consistent with the present disclosure, urban mobility management system 100 may receive from a plurality of personal transportation vehicles location information. The location information may be generated by GPS components associated with a plurality of communication devices attached to the personal transportation vehicles. Urban mobility management system 100 may also obtain battery-charge information associated with at least some of the plurality of personal transportation vehicles. The battery-charge information may be indicative of a duration in which each personal transportation vehicle can operate without charging. Obtaining the battery-charge information may be achieved by receiving reports from a plurality of communication devices attached to the personal transportation vehicles. Alternatively, obtaining the battery-charge information may be achieved by estimating the current charge of personal transportation vehicles based on data indicative of the total distance they traveled since the last time they were charged. Based on the received information, urban mobility management system 100 may identify a need for relocating a plurality of personal transportation vehicles to different locations and determine transport task for answering the identified need.

In a first implementation, a processing device of urban mobility management system 100 may access a memory (e.g., database 170 or database 914) configured to store historical data associated with past demand for personal transportation vehicles in a geographical area. Based on the stored data, the processing device may determine locations associated with a predicted demand for personal transportation vehicles. Specifically, in the geographical area illustrated in FIG. 14, the processing device may identify a low demand area 1402 and a high demand area 1404. In one embodiment, the historical data may be used to determine a time dependent predicted demand. For example, in the mornings there may be demand in locations A1, A2, A3 and in the afternoons there may be demand in locations B1, B2, B3. The processing device may identify a need for relocation one or more personal transportation vehicles based on the location information and the predicted demand. Thereafter, processing device may determine transport tasks for the identified one or more personal transportation vehicles. The transport tasks may include a desired destination associated with a location having a predicted demand for personal transportation vehicles. Based on the determined transport tasks, the processing device may determine transportation routes for the personal transportation vehicles. In the depicted example, the processing device may identify that personal transportation vehicles 608A, 608B, and 608C are in low demand area 1402 and that they should be relocated to high demand area 1404. In the illustrated example, personal transportation vehicles 608D is also in low demand area 1402 but it cannot be relocated to high demand area 1404 because it has low battery charge. Specifically, urban mobility management system 100 may determine a transportation route 1400A for relocating personal transportation vehicle 608A using multi-person transportation vehicle 606A from pick-up location 1406 to drop-off location 1408; determine a transportation route 1400B for relocating personal transportation vehicle 608B by instructing personal transportation vehicle 608B to autonomously drive from its current location to pick-up location 1410 and instructing multi-person transportation vehicle 606A to transport personal transportation vehicle 608B from pick-up location 1410 to drop-off location 1412; and determine a transportation route 1400C for relocating personal transportation vehicle 608C using user 602A from collection point 1414 to parking point 1416. As illustrated, user 602A may be instructed to park personal transportation vehicle 608C inside high demand area 1404 and to walk to desired destination 1418.

In a second implementation, a processing device of urban mobility management system 100 may identify, from the current battery-charge information, one or more personal transportation vehicles in need of a charge. In some embodiments, the processing device may use different battery charge thresholds corresponding with different hours of the day (e.g., before rush hour, during rush hour) to identify the specific personal transportation vehicle. The processing device may access a memory (e.g., database 170 or database 914) configured to store locations of a plurality of charging stations located within a geographic area. Based on the current location of the personal transportation vehicle in need of a charge, the processing device may select a charging station for the personal transportation vehicle. Thereafter, processing device may determine transport tasks for the identified one or more personal transportation vehicles. The transport tasks may include a desired destination for the identified one or more personal transportation vehicles at the selected charging station. In some cases, the selection of the charging station may be based on occupancy data indicative of a capacity utilization for each charging station. The occupancy data may be indicative of current and predicted capacity utilization for each charging station. Based on the determined transport tasks, the processing device may determine transportation routes for the personal transportation vehicles in need of a recharge. In the depicted example, the processing device may identify that personal transportation vehicles 608D and 608E need a battery recharge. Specifically, urban mobility management system 100 may determine a transportation route 1400D for relocating personal transportation vehicle 608D using multi-person transportation vehicle 606A from pick-up location 1420 to drop-off location 1422; and determine a transportation route 1400E for relocating personal transportation vehicle 608E using multi-person transportation vehicle 606B from pick-up location 1424 to drop-off location 1426. Both drop-off location 1422 and drop-off location 1426 are part of charging station 1428.

Consistent with the present disclosure, a processing device of urban mobility management system 100 may provide driving instructions to one or more multi-person transportation vehicles for transporting multiple users based on ride requests and for transporting a plurality of personal transportation vehicles based on identified need. The multi-person transportation vehicles may or may not concurrently transport the users and personal transportation vehicles. In the illustrated example, urban mobility management system 100 may instruct a driver of multi-person transportation vehicle 606A to pick up personal transportation vehicle 608A at pick-up location 1406, then to pick up personal transportation vehicle 608B at pick-up location 14010, then to pick up personal transportation vehicle 608D at pick-up location 1420, then to pick up user 602B at pick-up location 1430, then to drop off personal transportation vehicles 608A and 608B in high demand area 1404, then to drop off personal transportation vehicle 608D in charging station 1428. Urban mobility management system 100 may also instruct a driver of multi-person transportation vehicle 606B to pick up personal transportation vehicle 608E at pick-up location 1424 and to drop off personal transportation vehicle 608D in charging station 1428.

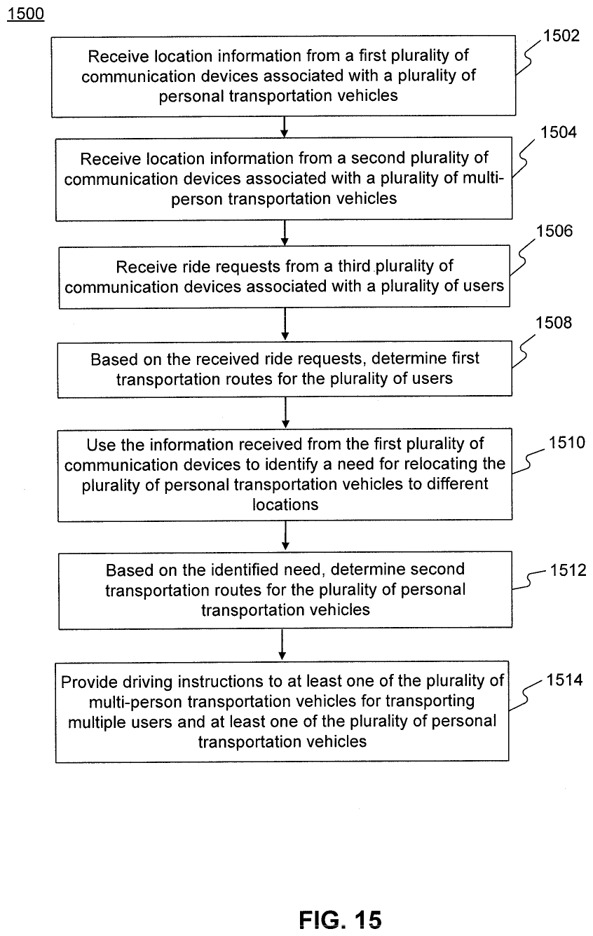

FIG. 15 is a flowchart of an example method 1500 for managing transportation of users and personal transportation vehicles executed by a processing device of urban mobility management system 100, according to embodiments of the present disclosure. For the purposes of illustration, in the following description reference is made to certain components of urban mobility management system 100. It will be appreciated, however, that other implementations are possible and that any combination of components or devices may be utilized to implement the exemplary method. It will also be readily appreciated that the illustrated method can be altered to modify the order of steps, delete steps, or further include additional steps.

At step 1502, a processing device (e.g., processor 310) may receive information from a first plurality of communication devices associated with a plurality of personal transportation vehicles. At step 1504, the processing device may receive information from a second plurality of communication devices associated with a plurality of multi-person transportation vehicles. At step 1506, the processing device may receive ride requests from a third plurality of communication devices associated with a plurality of users. Steps 1502-1506 are similar to steps 1002-1006 described in detail above and are not repeated herein.

At step 1508, the processing device may determine first transportation routes for the plurality of users based on the received ride requests. Consistent with the present disclosure, the first transportation routes may include at least one route in which a user among the plurality of users may use a personal transportation vehicle among the plurality of personal transportation vehicles for transportation. The first transportation routes may also include at least one route in which another user among the plurality of users may use a multi-person transportation vehicle among the plurality of multi-transportation vehicles for transportation. Examples for the first transportation routes according to the present disclosure may include transportation routes 1200A, 1200B, and 1200C. In one embodiment, the first transportation routes may include at least one route that includes at least one segment in which the user may be assigned to a personal transportation vehicle among the plurality of personal transportation vehicles and at least one segment in which the user may be assigned to a multi-person transportation vehicle among the plurality of multi-transportation vehicles. An example for the first transportation routes according to this embodiment includes optional transportation route 700C.

At step 1510, the processing device may use information received from the first plurality of communication devices to identify a need for relocating the plurality of personal transportation vehicles to different locations. In one embodiment, the identified need for relocating a specific personal transportation vehicle to a different location may be based on a determination that the specific personal transportation vehicle was parked in a prohibited location. For example, a user may park the specific personal transportation vehicle in an entrance of an office building and not in a designated space. In another embodiment, the identified need for relocating a specific personal transportation vehicle to a different location may be based on received information on predicted environmental conditions. For example, the processing device may receive weather updates and determine that at least some of the personal transportation vehicles may be parked in locations associated with high risk of being damaged, for example, areas with a high flood risk. In another embodiment, the identified need for relocating a specific personal transportation vehicle to a different location may be based on received input from a user about the specific personal transportation vehicle. For example, the processing device may receive a report from a user indicating that the specific personal transportation vehicle has a malfunction. Based on the determined malfunction, the processing device may identify a need for relocating the specific personal transportation vehicle to a workshop.

At step 1512, the processing device may determine second transportation routes for the plurality of personal transportation vehicles based on the identified need. Consistent with the present disclosure, the second transportation routes may include at least one route in which one of the plurality of personal transportation vehicles may be relocated by one of the plurality of multi-person transportation vehicles. Additionally, the second transportation routes may further include at least one route in which another one of the plurality of personal transportation vehicles may be relocated by a user among the plurality of users. In one embodiment, the processing device may determine a transport task for a specific personal transportation vehicle. The transport task may include a desired destination for the specific personal transportation vehicle. According to a first implementation, the transport task may be assigned to a multi-person transportation vehicle. Specifically, the processing device may allocate a specific personal transportation vehicle to a multi-person transportation vehicle. In one embodiment, allocating the specific personal transportation vehicle to a multi-person transportation vehicle may include providing a driver of the multi-person transportation vehicle with details regarding a location for picking up the specific personal transportation vehicle and details regarding a location for dropping off the specific personal transportation vehicle. According to a second implementation, the transport task may be assigned to a user. Specifically, the processing device may allocate a specific personal transportation vehicle to a user requesting transportation. In one embodiment, allocating the specific personal transportation vehicle to a user may include providing details to the specific user regarding a location for collecting the specific personal transportation vehicle (e.g., collection point 1414) and details regarding a location for parking the specific personal transportation vehicle (e.g., parking point 1416). In some embodiments, the processing device may determine the location for dropping off and/or the location for parking the specific personal transportation vehicle based on the transport task and based on other tasks. For example, a first multi-person transportation vehicle may be instructed to drop-off a personal transportation vehicle at a location where a second multi-person transportation vehicle may drop a user scheduled to use the personal transportation vehicle.

After determining a second transportation routes for a plurality of personal transportation vehicles, the processing device may assign a multi-person transportation vehicle to transport at least one of the plurality of personal transportation vehicles. While the processing device may prefer to assign empty multi-person transportation vehicles for relocating the personal transportation vehicles, this may not happen all the times. The reason is that a single fleet of multi-person transportation vehicles may be used for answering the transportation needs of both human users and personal transportation vehicles. Accordingly, the processing device may determine that human users will share their ride with personal transportation vehicles in order to improve the overall transportation service. Consistent with the present disclosure, the processing device may follow predetermined rules for providing services to different types of customers (i.e., human users and personal transportation vehicles). In some cases, the processing device may cancel a pending assignment while the multi-person transportation vehicle is en route to the at least one personal transportation based on a received ride request from a user. Additionally, the processing device may assign a multi-person transportation vehicle to transport at least one user while relocating at least one personal transportation vehicle. A shared ride of a user and a personal transportation vehicle may take place even when the destinations of the user and a personal transportation vehicle are distinct from each other.

At step 1514, the processing device may provide driving instructions to at least one of the plurality of multi-person transportation vehicles for transporting multiple users and at least one of the plurality of personal transportation vehicles. In one embodiment, the driving instructions provided to the multi-person transportation vehicle may cause simultaneously transporting multiple users and at least one personal transportation vehicle. In another embodiment, the driving instructions provided to the multi-person transportation vehicle may cause transporting multiple users during a first time period and transporting at least one personal transportation vehicle during a second time period. The second time period may be separated and non-overlapping with the first time period. For example, the driving instructions to a specific multi-person transportation vehicle may include picking up at least one personal transportation vehicle after completing a ride with passengers and picking up additional passengers only after dropping off the at least one personal transportation vehicle. In one example scenario, the driving instructions provided to a driver of a specific multi-person transportation may include: an instruction to pick up a first user associated with a first desired destination at a first pick-up location; an instruction to, while transporting the first user, pick up a second user associated with a second desired destination at a second pick-up location, wherein the second desired destination differs than the first destination; an instruction to, while transporting the first user and the second user, pick up a personal transportation vehicle; and an instruction to drop off the personal transportation vehicle before dropping off the second user.

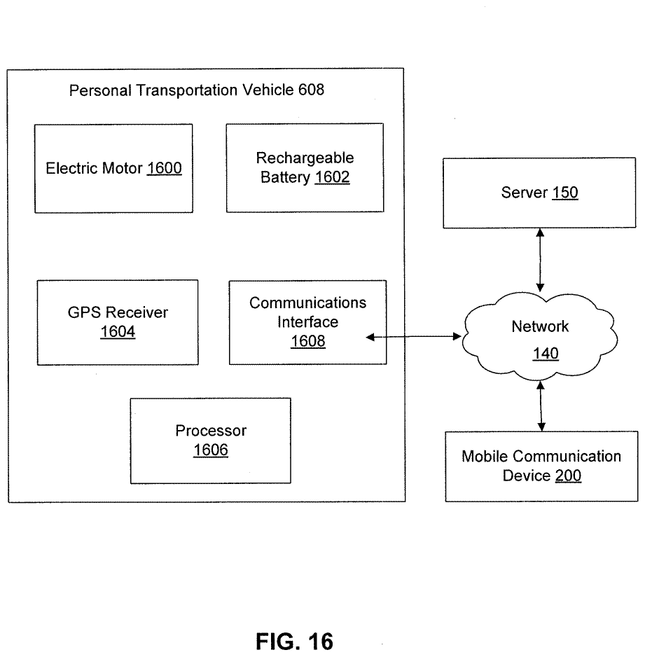

FIG. 16 is a diagram illustrating the components of an example personal transportation vehicle 608 associated with an urban mobility management system, such as system 100 as shown in FIG. 1. Personal transportation vehicle 608 may be used to transport a user from one location to another location. As illustrated, personal transportation vehicle 608 may include an electric motor 1600, a rechargeable battery 1602, a GPS receiver 1604, processor 1606, and a communications interface 1608. GPS receiver 1604, processor 1606, and communications interface 1608 may be separate components or may be integrated in one or more integrated circuits. The various components in personal transportation vehicle 608 may be coupled by one or more communication buses or signal lines.

In some embodiments, electric motor 1600 may use a gearbox to produce different rotation ratios between a drive motor and drive wheels during use of personal transportation vehicle. This differential may absorb power of the gearbox to overcome rotation speed differences between the drive wheels, and two (or more) wheel axles that are used to deliver the power to the drive wheels from the differential. Alternatively or in addition, other electrical vehicle powering and gear means known in the art may also be used.

Consistent with the present disclosure, rechargeable battery 1602 may store electricity for powering personal transportation vehicle 608. Rechargeable battery 1602 may be recharged from time to time. This may typically be done by plugging rechargeable battery 1602 into an AC power outlet for some period of time to restore the depleted energy. In one embodiment, rechargeable battery 1602 may be a battery pack that is modular and easily concealed in the frame of personal transportation vehicle 608. In some embodiments, rechargeable battery 1602 may include, without limitation, a lithium-ion battery, a nickel-metal hydride battery, a lead-acid battery, and an ultra-capacitor. In one embodiment, rechargeable battery 1602 may receive a power charge from an external power source (e.g., charging station 1428).

In other embodiments, personal transportation vehicle 608 may include GPS receiver 1604, which may be integral with personal transportation vehicle 608. GPS receiver 1604 may provide geolocation and time information to server 150, which may handle ridesharing vehicles and personal transportation vehicles assignment based on ride requests. Using the information from GPS receiver 1604, user 602 may view the location of personal transportation vehicle 608 on an associated communication device (e.g., mobile communications device 200).

In one exemplary use of GPS receiver 1604, personal transportation vehicle 608 may be equipped with a navigation system that provides driving instructions to user 602 from server 150. For example, server 150 may guide user 602 to a parking point for personal transportation vehicle 608 that may be within a walking distance from the user's desired destination. GPS receiver 1604 may include an antenna to receive signals from a satellite network. The navigation system may use the satellite positioning signals to compute coordinates identifying a location of personal transportation vehicle 608 on the surface of the earth with regard to longitude, latitude, and/or altitude. GPS receiver 1604 may also be in communication with the mobile communication device 200 to enable user 602 to view the position of personal transportation vehicle 608. Additionally, with appropriate map software, the vehicle's location may then be shown on a map visible on the mobile communication device 200.

Processor 1606 and communications interface 1608 may be used to communicate with server 150 in order to enable server 150 to identify a one or more personal transportation to relocate in order to recharge batteries. Specifically, processor 1606 may provide updated information to server 150. The updated information may include location information (e.g., data generated by at least one GPS receiver 1604) and/or battery charge status (e.g., data indicative of the status of rechargeable battery 1602). In some embodiment, processor 1606 may unlock personal transportation vehicle 608 upon receiving a token (e.g., data, password, etc.) from mobile communication device 200. The token may be provided to mobile communication device 200 from server 150 after personal transportation vehicle 608 was assigned to user 602.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, e.g., hard disks or CD ROM, or other forms of RAM or ROM, USB media, DVD, Blu-ray, Ultra HD Blu-ray, or other optical drive media.

Computer programs based on the written description and disclosed methods are within the skills of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The examples are to be construed as non-exclusive. Furthermore, the steps of the disclosed methods may be modified in any manner, including by reordering steps and/or inserting or deleting steps. It is intended, therefore, that the specification and examples be considered as illustrative only.

1. A system for providing transportation, the system comprising:
a communications interface configured to:
receive location information from a first plurality of communication devices associated with a plurality of personal transportation vehicles;
receive location information from a second plurality of communication devices associated with a plurality of multi-person transportation vehicles;
receive ride requests from a third plurality of communication devices associated with a plurality of users, wherein each ride request includes a starting point and a desired destination corresponding to each of the plurality of users; and
at least one processor configured to:
determine optional transportation routes for the plurality of users based on the ride requests, the location information from the plurality of personal transportation vehicles, and the location information from the plurality of multi-personal transportation vehicles;
determine a transportation route for a user among the plurality of users, wherein the transportation route includes at least one segment in which the user is assigned to a personal transportation vehicle among the plurality of personal transportation vehicles and at least one segment in which the user is assigned to a multi-person transportation vehicle among the plurality of multi-transportation vehicles; and
provide the user with information about the transportation route, wherein the information includes details about a collection point from which the user is scheduled to collect the assigned personal transportation vehicle and details about a pick-up location from which the assigned multi-person transportation vehicle is scheduled to pick up the user.

2. The system of claim 1, wherein the plurality of personal transportation vehicles includes at least one motorized vehicle capable of transporting the user from the collection point to a parking point.

3. The system of claim 1, wherein, when the plurality of personal transportation vehicles are manually operated, the at least one processor is further configured to determine optional transportation routes for the user by confirming that the user can operate the assigned personal transportation vehicle.

4. The system of claim 1, wherein, when the plurality of personal transportation vehicles are electrically powered, the at least one processor is configured to determine optional transportation routes for the user by considering a battery charge level of each of the plurality of personal transportation vehicles.

5. The system of claim 1, wherein the plurality of multi-person transportation vehicles includes at least one autonomous vehicle capable of transporting at least two passengers at a same time.

6. The system of claim 1, wherein, when the plurality of multi-person transportation vehicles includes ridesharing vehicles, the at least one processor is further configured to determine optional transportation routes for the user by considering desired destinations of other users currently assigned to the plurality of multi-person transportation vehicles.

7. The system of claim 1, wherein the at least one processor is further configured to determine optional transportation routes for the user by considering scheduled pick-up locations of other users assigned to the multi-person transportation vehicle assigned to the user.

8. The system of claim 1, wherein the at least one processor is further configured to determine optional transportation routes for the user by considering map data indicative of roads prohibited to personal transportation devices.

9. The system of claim 1, wherein the at least one processor is further configured to provide the user with a proposal including a first optional transportation route and a second optional transportation route, and wherein the first optional transportation route is associated with a first collection point located in a different location than a second collection point of the second optional transportation route.

10. The system of claim 9, wherein the at least one processor is further configured to receive data indicative of a user selection of the first optional transportation route, and to select the transportation route for the user based on the user selection.

11-21. (canceled)

22. A method for providing multiple transportation proposals to a user, the method comprising:
receiving location information from a first plurality of communication devices associated with a plurality of personal transportation vehicles;
receiving location information from a second plurality of communication devices associated with a plurality of multi-person transportation vehicles;
receiving ride requests from a third plurality of communication devices associated with a plurality of users, wherein each ride request includes a starting point and a desired destination corresponding to each of the plurality of users;
determining optional transportation routes for the user based on a corresponding ride request, the location information from the plurality of personal transportation vehicles, and the location information from the plurality of multi-personal transportation vehicles;
determining a first transportation route proposal for the user that includes using at least a personal transportation vehicle from the plurality of personal transportation vehicles, wherein the first transportation route proposal is associated with a first travel time;
determining a second transportation route proposal for the user that includes using at least a multi-personal transportation vehicle from the plurality of multi-transportation vehicles, wherein the second transportation route proposal is associated with a second travel time other than the first travel time;
providing the user information associated with the first transportation route proposal and the second transportation route proposal;
receiving from the user a proposal selection reflective of at least one selected vehicle for transportation; and
assigning the at least one selected vehicle to the user based on the received proposal selection.

23. The method of claim 22, wherein:
when the user selects the first transportation route proposal, the method further comprising providing the user with information about a collection point from which the user is scheduled to collect the personal transportation vehicle, and
when the user selects the second transportation route proposal, the method further comprising providing the user with information about a pick-up location from which the multi-person transportation vehicle is scheduled to pick up the user.

24. The method of claim 22, wherein the first transportation route includes at least one segment in which the user is assigned to a first personal transportation vehicle and at least one segment in which the user is assigned to a first multi-person transportation vehicle and the second transportation route includes at least one segment in which the user is assigned to a second personal transportation vehicle and at least one segment in which the user is assigned to a second multi-person transportation vehicle.

25. The method of claim 22, wherein the information provided to the user includes details indicative of an estimated time of arrival for each of the first transportation route proposal and the second transportation route proposal.

26. A system for managing transportation of users and personal transportation vehicles, the system comprising:
a communications interface configured to:
receive information from a first plurality of communication devices associated with a plurality of personal transportation vehicles;
receive information from a second plurality of communication devices associated with a plurality of multi-person transportation vehicles;
receive ride requests from a third plurality of communication devices associated with a plurality of users, wherein each ride request includes a starting point and a desired destination corresponding to each of the plurality of users; and
at least one processor configured to:
based on the received ride requests, determine first transportation routes for the plurality of users, wherein the first transportation routes include at least one route in which a user among the plurality of users uses a personal transportation vehicle among the plurality of personal transportation vehicles for transportation and at least one route in which another user among the plurality of users uses a multi-person transportation vehicle among the plurality of multi-transportation vehicles for transportation;
use the information received from the first plurality of communication devices to identify a need for relocating the plurality of personal transportation vehicles to different locations;
based on the identified need, determine second transportation routes for the plurality of personal transportation vehicles, wherein the second transportation routes include at least one route in which one of the plurality of personal transportation vehicles is relocated by one of the plurality of multi-person transportation vehicles; and
provide driving instructions to at least one of the plurality of multi-person transportation vehicles for transporting multiple users and at least one of the plurality of personal transportation vehicles.

27. The system of claim 26, wherein the second transportation routes further include at least one route in which another one of the plurality of personal transportation vehicles is relocated by another user among the plurality of users.

28. The system of claim 27, wherein the at least one processor is further configured to:
determine a transport task for a specific personal transportation vehicle, wherein the transport task includes a desired destination for the specific personal transportation vehicle;
allocate the specific personal transportation vehicle to a specific user, wherein allocating the specific personal transportation vehicle to the specific user includes providing details to the specific user regarding a location for collecting the specific personal transportation vehicle and regarding a location for parking the specific personal transportation vehicle; and
determine the location for parking the specific personal transportation vehicle based on the transport task.

29. The system of claim 26, wherein the at least one processor is further configured to:
determine a transport task for a specific personal transportation vehicle, wherein the transport task includes a desired destination for the specific personal transportation vehicle;
allocate the specific personal transportation vehicle to a multi-person transportation vehicle, wherein allocating the specific personal transportation vehicle to a multi-person transportation vehicle includes providing a driver of the multi-person transportation vehicle details regarding a location for picking up the specific personal transportation vehicle and regarding a location for dropping off the specific personal transportation vehicle; and
determine the location for dropping off the specific personal transportation vehicle based on the transport task.

30. The system of claim 26, wherein the communications interface is configured to receive from the plurality of personal transportation vehicles location information, the location information includes global positioning system (GPS) data generated by GPS components associated with the first plurality of communication devices.

31. The system of claim 30, wherein the at least one processor is further configured to:
access a memory storing historical data associated with past demand for personal transportation vehicles in a geographical area;
determine locations associated with a predicted demand for personal transportation vehicles; and
based on the location information and the predicted demand, identify a specific personal transportation vehicle for relocation.

32. The system of claim 31, wherein the at least one processor is further configured to determine a transport task for the specific personal transportation vehicle, the transport task including a desired destination associated with a location having a predicted demand for personal transportation vehicles.

33. The system of claim 26, wherein the communications interface is configured to receive from at least some of the plurality of personal transportation vehicles battery-charge information, the battery-charge information being indicative of a duration in which each personal transportation vehicle can operate without charging.

34. The system of claim 33, wherein the at least one processor is further configured to identify, from the current battery-charge information, a specific personal transportation vehicle in need of a charge.

35. The system of claim 34, wherein the at least one processor is further configured to:
access a memory storing locations of a plurality of charging stations located within a geographic area;
select a charging station for the personal transportation vehicle; and
determine a transport task for the specific personal transportation vehicle, the transportation task including a desired destination for the specific personal transportation vehicle at the selected charging station.

36. The system of claim 26, wherein the at least one processor is further configured to determine a second transportation route for a specific personal transportation vehicle, the second transportation route including a first segment in which the specific personal transportation vehicle is assigned to be relocated by a user and a second segment in which the specific personal transportation vehicle is assigned to be relocated by a multi-person transportation vehicle.

37. The system of claim 26, wherein the at least one processor is further configured to assign a multi-person transportation vehicle to transport a specific personal transportation vehicle and to cancel the assignment while the multi-person transportation vehicle is en route to the specific personal transportation based on a received ride request from a user.

38. The system of claim 26, wherein the at least one processor is further configured to allocate a multi-person transportation vehicle to transport a specific personal transportation vehicle, wherein the multi-person transportation vehicle is assigned to transport at least one user while relocating the specific personal transportation vehicle.

39. The system of claim 26, wherein the at least one processor is further configured to determine a pick-up location for at least one user based on a desired destination of a specific personal transportation vehicle.

40. The system of claim 26, wherein the at least one processor is further configured to determine a drop-off location for at least one user based on a desired destination a specific personal transportation vehicle.

41. The system of claim 40, wherein the at least one processor is further configured to determine the drop-off location for the at least one user after the multi-person transportation vehicle was allocated to transport the specific personal transportation vehicle and while the at least one user is riding the multi-person transportation vehicle.

42-47. (canceled)
